(19) United States
(12) Patent Application Publication
(10) Pub. No.: US 2025/0385731 A1
(43) Pub. Date: Dec. 18, 2025

(54) METHODS, COMMUNICATIONS DEVICES, AND NON-TERRESTRIAL INFRASTRUCTURE EQUIPMENT

(71) Applicant: Sony Group Corporation, Tokyo (JP)

(72) Inventors: Yuxin WEI, Basingstoke (GB); Vivek SHARMA, Basingstoke (GB); Yassin Aden AWAD, Basingstoke (GB); Hideji WAKABAYASHI, Basingstoke (GB)

(73) Assignee: Sony Group Corporation, Tokyo (JP)

(21) Appl. No.: 18/877,513

(22) PCT Filed: Jun. 7, 2023
(86) PCT No.: PCT/EP2023/065283

§ 371 Date: Dec. 20, 2024

(30) Foreign Application Priority Data
Jun. 29, 2022 (EP) 22182010.3

(51) Int. Cl. H04B 7/185; H04W 76/20; H04W 80/02

(52) U.S. Cl. CPC H04B 7/18541; H04B 7/1855; H04W 76/20; H04W 80/02

(57) ABSTRACT

A method of operating a communications device to perform intra-cell or inter-cell mobility procedures with a non-terrestrial network, NTN, comprising: receiving, from the NTN, an indication of beams belonging to the same or different communications cells provided by the NTN; receiving, from the NTN, a condition for activating each beam for communications between the communications device and the NTN; determining the condition is being met for at least one beam which comprises activating the beam for communications for as long as at least one of the following conditions is met: indication of a time period condition for each beam during which the respective beam should be active for communications between the communications device and the NTN, indication of a location range condition for each beam for the communications device during which the respective beam should be active for communications between the communications device and the NTN.

### BACKGROUND

### Field of Disclosure

The present disclosure relates to communications devices, non-terrestrial infrastructure equipment and methods of operating communications devices and non-terrestrial infrastructure equipment to perform an intra-cell or inter-cell mobility procedure, and beam failure recovery.

The present application claims the Paris Convention priority of European patent application number EP22182010.3, the contents of which are hereby incorporated by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these and future networks, i.e. geographic locations where access to the networks is possible, may be expected to increase ever more rapidly.

Current and future wireless communications networks are expected to routinely and efficiently support communications with a wider range of devices associated with a wider range of data traffic profiles and types than previously developed systems are optimised to support. For example, it is expected that future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for more advanced wireless communications networks, for example those which may be referred to as 5G or new radio (NR) system/new radio access technology (RAT) systems, as well as future iterations/releases of existing systems, to efficiently support connectivity for a wide range of devices associated with different applications and different characteristic data traffic profiles.

One example area of current interest in this regard includes so-called “non-terrestrial networks”, or NTN for short. 3GPP has proposed in Release 15 of the 3GPP specifications to develop technologies for providing coverage by means of one or more antennas mounted on airborne or space-borne vehicles [1].

Non-terrestrial networks may provide service in areas that cannot be covered by terrestrial cellular networks (i.e. those where coverage is provided by means of land-based antennas), such as isolated or remote areas, on board aircraft or vessels) or may provide enhanced service in other areas. The expanded coverage that may be achieved by means of non-terrestrial networks may provide service continuity for machine-to-machine (M2M) or ‘internet of things’ (IoT) devices, or for passengers on board moving platforms (e.g. passenger vehicles such as aircraft, ships, high speed trains, or buses). Other benefits may arise from the use of non-terrestrial networks for providing multicast/broadcast resources for data delivery.

The use of network infrastructure equipment and requirements for coverage enhancement give rise to new challenges for efficiently handling communications in wireless communications systems that need to be addressed.

### SUMMARY OF THE DISCLOSURE

The present disclosure can help address or mitigate at least some of the issues discussed above.

According to one aspect of the present disclosure, example embodiments can provide a method of operating a communications device to perform an intra-cell or inter-cell mobility procedure with a non-terrestrial network, NTN. The method comprises receiving, from the NTN, an indication of a plurality of beams belonging to the same or different communications cells provided by the NTN. For example, the plurality of beams may include a plurality of beams belonging to the same communications cell provided by the NTN or the plurality of beams may include one or more beams belonging to a first communications cell provided by the NTN and one or more beams belonging to a second, different communications cell provided by the NTN. The method comprises receiving, from the NTN, a condition for activating each of the plurality of beams for communications between the communications device and the NTN. That is, communication on the uplink from the communications device to the NTN and/or communication on the downlink from the NTN to the communications device. The method comprises determining that the condition is being met for at least one of the beams. The method comprises activating the at least one beam for communications between the communications device and the NTN for as long as the condition is being met. The condition comprises at least one of: a time period condition for each of the plurality of beams indicating a time period during which the respective beam should be active for communications between the communications device and the NTN, and a location range condition for each of the plurality of beams indicating a location range for the communications device during which the respective beam should be active for communications between the communications device and the NTN.

According to another aspect of the present disclosure, example embodiments can provide a method of operating a communications device to perform an intra-cell or inter-cell mobility procedure with a non-terrestrial network, NTN. The method comprises receiving, from the NTN, an indication of a plurality of beams belonging to the same or different communications cells provided by the NTN. For example, the plurality of beams may include a plurality of beams belonging to the same communications cell provided by the NTN or the plurality of beams may include one or more beams belonging to a first communications cell provided by the NTN and one or more beams belonging to a second, different communications cell provided by the NTN. The method comprises receiving, from the NTN, a condition for deactivating each of the plurality of beams for communications between the communications device and the NTN. That is, communication on the uplink from the communications device to the NTN and/or communication on the downlink from the NTN to the communications device. The method comprises determining that the condition is being met for at least one of the beams. The method comprises deactivating the at least one beam for communications between the communications device and the NTN for as long as the condition is being met. The condition comprises at least one of: a time period condition for each of the plurality of beams indicating a time period during which the respective beam should be inactive for communications between the communications device and the NTN, and a location range condition for each of the plurality of beams indicating a location range for the communications device during which the respective beam should be inactive for communications between the communications device and the NTN.

Such embodiments can provide improvements to existing inter-cell and intra-cell mobility procedures. For example, as will be appreciated from an understanding of the following detailed description, embodiments can provide reduce control signalling, increased flexibility and reduced power consumption in inter-cell and intra-cell mobility procedures.

According to another aspect of the present disclosure, example embodiments can provide a method of operating a communications device to perform beam failure recovery with a non-terrestrial network, NTN. The method comprises receiving, from the NTN, a beam failure recovery configuration identifying one or more beams provided by the NTN as candidate beams for communications between the communications device and the NTN after beam failure. The beam failure recovery configuration comprises an indication of a time period for each of the one or more candidate beams during which the communications device is expected to be in a coverage area provided by the respective candidate beam. The method comprises determining that beam failure has occurred. The method comprises selecting one of the candidate beams for communications between the communications device and the NTN based on the indication of the time period for each of the one or more candidate beams. The method comprises transmitting, to the NTN, a control message indicating the selected beam.

Such embodiments can provide improvements to existing beam failure recovery procedures. For example, as will be appreciated from an understanding of the following detailed description, embodiments can provide increase communications resource utilisation efficiency.

Respective aspects and features of the present disclosure are defined in the appended claims, which includes communications devices, NTN infrastructure equipment and methods of operating NTN infrastructure equipment.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device configured in accordance with example embodiments;

FIG. 4 schematically shows an example of a communications device in a non-terrestrial network which may be configured to operate in accordance with embodiments of the present disclosure;

FIG. 5 is reproduced from [1], and illustrates a first example of a non-terrestrial network featuring an access networking service based on a satellite/aerial platform with a bent pipe payload;

FIG. 6 is reproduced from [1], and illustrates a second example of an NTN featuring an access networking service based on a satellite/aerial platform connected to a gNodeB;

FIG. 7a schematically illustrates an example of an intra-cell mobility procedure between beams of an NTN aerial vehicle;

FIG. 7b schematically illustrates an example of an inter-cell mobility procedure between beams of an NTN aerial vehicle;

FIG. 7c schematically illustrates an example of an inter-cell mobility procedure between beams of a plurality of NTN aerial vehicles;

FIG. 8a schematically illustrates a MAC CE for PDSCH;

FIG. 8b schematically illustrates a MAC CE for PUCCH;

FIG. 9 is a flow diagram illustrating a method of operating a communications device to perform an intra-cell or inter-cell mobility procedure with an NTN in accordance with example embodiments;

FIG. 10a schematically illustrates a UE-specific PDCCH MAC CE for TCI state activation/deactivation which can be adapted to include a condition for activating each of one or more beams in accordance with example embodiments;

FIG. 10b illustrates a multiple TRP PUCCH repetition MAC CE which can be adapted to include a condition for activating each of one or more beams in accordance with example embodiments;

FIG. 10c schematically illustrates a MAC CE for unified TCI state activation/deactivation which can be adapted to include a condition for activating each of one or more beams in accordance with example embodiments;

FIG. 11 schematically illustrates a single panel communications device performing an inter-cell mobility procedure in accordance with example embodiments;

FIG. 12 schematically illustrates a multi panel communications device performing an inter-cell mobility procedure in accordance with example embodiments;

FIG. 13 schematically illustrates a beam failure recovery serving cell configuration element which can be adapted to include a service time for one or more candidate beams in accordance with example embodiments;

FIG. 14 is a flow diagram illustrating a method of operating a communications device to perform beam failure recovery with an NTN in accordance with example embodiments;

FIG. 15 schematically illustrates an enhanced or truncated enhanced beam failure recovery MAC CE which can be adapted to include an indication of a location of a communications device in accordance with example embodiments.

### DETAILED DESCRIPTION OF THE EMBODIMENTS

### Long Term Evolution Advanced Radio Access Technology (4G)

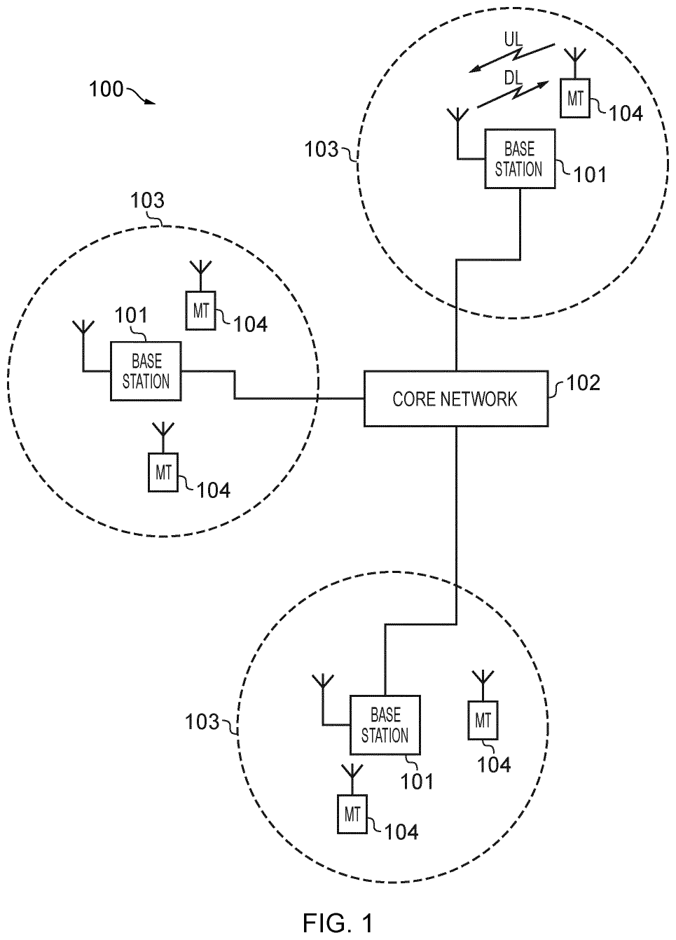

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a communications cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs (eNB), g-nodeBs (gNB) and so forth. In this regard, different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G NR)

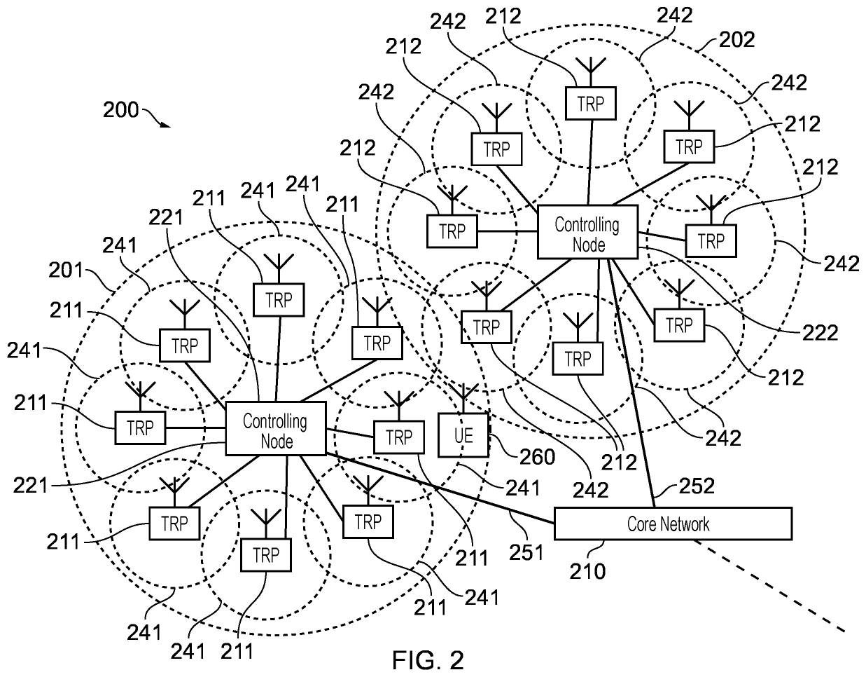

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communications cell 201 and a second communications cell 202. Each communications cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units (DUs) 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communications cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communications cell 201. This communications device 260 may thus exchange signalling with the first controlling node 221 in the first communications cell via one of the distributed units 211 associated with the first communications cell 201. In some cases, communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communications cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

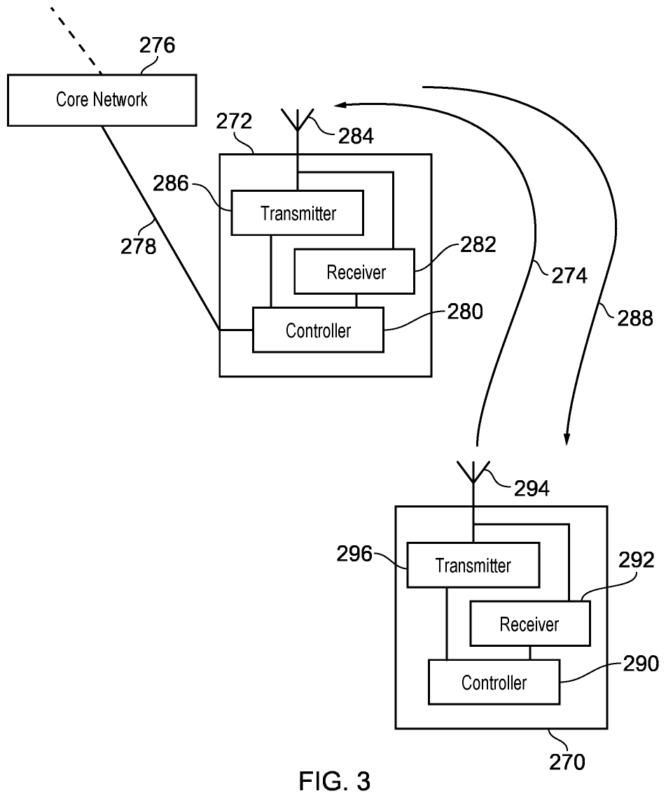

A more detailed illustration of a communications device 270 and an example network infrastructure equipment 272, which may be thought of as an eNB or a gNB 101 or a combination of a controlling node 221 and TRP 211, is presented in FIG. 3. As shown in FIG. 3, the communications device 270 is shown to transmit uplink data to the infrastructure equipment 272 of a wireless access interface as illustrated generally by an arrow 274. The UE 270 is shown to receive downlink data transmitted by the infrastructure equipment 272 via resources of the wireless access interface as illustrated generally by an arrow 288. As with FIGS. 1 and 2, the infrastructure equipment 272 is connected to a core network 276 (which may correspond to the core network 102 of FIG. 1 or the core network 210 of FIG. 2) via an interface 278 to a controller 280 of the infrastructure equipment 272. The infrastructure equipment 272 may additionally be connected to other similar infrastructure equipment by means of an inter-radio access network node interface, not shown on FIG. 3. The infrastructure equipment 272 includes a receiver 282 connected to an antenna 284 and a transmitter 286 connected to the antenna 284. Correspondingly, the communications device 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the communications device 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, which may be non-volatile memory, operating according to instructions stored on a computer readable medium.

### Non-Terrestrial Networks (NTNs)

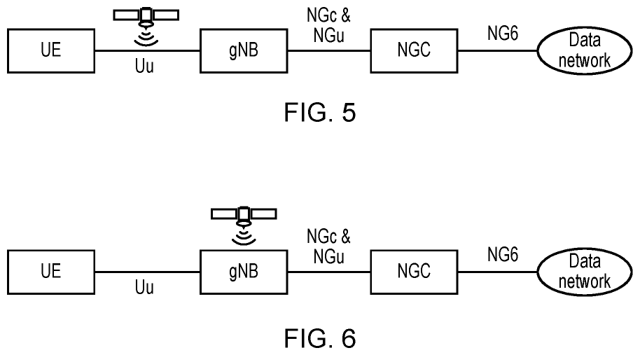

An overview of NR-NTN can be found in [1], and much of the following wording, along with FIGS. 5 and 6 below, has been reproduced from that document as a way of background.

An NTN aerial vehicle (such as a satellite or aerial platform) may allow a connection of a communications device and a ground station (which may be referred to herein as an NTN gateway). In the present disclosure, the term NTN aerial vehicle is used to refer to a space vehicle, aerial platform, or satellite, or any other entity which moves aerially relative to a communications device and is configured to communicate with a communications device. In particular, an NTN aerial vehicle may be in some embodiments a low earth orbit (LEO) satellite, a medium earth orbit (MEO) satellite, a high altitude platform system (HAPS), a balloon or a drone for example.

As a result of the wide service coverage capabilities and reduced vulnerability of space/airborne vehicles to physical attacks and natural disasters, NTNs are expected to:
foster the roll out of 5G service in un-served areas that cannot be covered by a terrestrial 5G network (isolated/remote areas, on board aircrafts or vessels) and underserved areas (e.g. sub-urban/rural areas) to upgrade the performance of limited terrestrial networks in a cost effective manner;
reinforce the 5G service reliability by providing service continuity for M2M/IoT devices or for passengers on board moving platforms (e.g. passenger vehicles-aircraft, ships, high speed trains, bus) or ensuring service availability anywhere especially for critical communications, future railway/maritime/aeronautical communications; and to
enable 5G network scalability by providing efficient multicast/broadcast resources for data delivery towards the network edges or even user terminal.

The benefits relate to either NTNs operating alone or to integrated terrestrial and Non-Terrestrial networks. They will impact at least coverage, user bandwidth, system capacity, service reliability or service availability, energy consumption and connection density. A role for NTN components in the 5G system is expected for at least the following verticals: transport, Public Safety, Media and Entertainment, eHealth, Energy, Agriculture, Finance and Automotive. It should also be noted that the same NTN benefits apply to 4G and/or LTE technologies and that while NR is sometimes referred to in the present disclosure, the teachings and techniques presented herein are equally applicable to 4G and/or LTE.

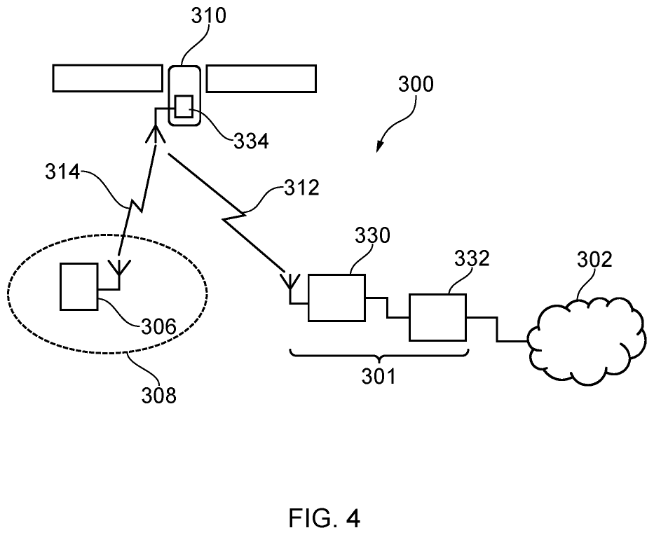

FIG. 4 schematically shows an example of a communications device 306 communicating with an NTN 300. The NTN 300 in FIG. 4 is based broadly around an LTE-type or NR-type architecture. Many aspects of the operation of the NTN 300 are known and understood and are not described here in detail in the interest of brevity. Operational aspects of the NTN which are not specifically described herein may be implemented in accordance with any known techniques, for example according to the current LTE-standards or the proposed NR standards.

The NTN 300 comprises a core network part 302 (which may be a 4G core network or a 5G core network) in communicative connection with a radio network part 301. The radio network part 301 comprises a base station 332 (such as a gNB) connected to a ground station (or NTN gateway) 330. The radio network part 301 may perform the functions of a base station 101 of FIG. 1, or may perform the functions of a controlling node and TRP of FIG. 2.

The NTN 300 also comprises an NTN aerial vehicle 310 which includes communications circuitry 334 for communicating with the communications device 306 and radio network part 301 via wireless communications links 314, 312.

The communications device 306 is located within a coverage area (for example, a communications cell) 308 provided by the NTN 300. In the example shown in FIG. 4, the coverage area 308 is provided a spot beam generated by the communications circuitry 334 of the NTN aerial vehicle 310. The boundary of the coverage area 308 may depend on an altitude of the NTN aerial vehicle 310 and a configuration of one or more antennas of the communications circuitry 334 by which the communications circuitry 334 transmits and receives signals from the communications device 306.

The spot beam may be an “earth fixed beam” which illuminates a geographic area on a surface of the earth for a pre-defined period of time. Alternatively, the spot beam may be an “earth moving beam” which illuminates a constantly changing geographic area on the surface of the earth. In this case, the communications device 306 may determine to switch from being served by the NTN aerial vehicle 310 to being served by the other NTN aerial vehicle based on decision criteria.

In FIG. 4, the ground station 330 is connected to the communications circuitry 334 by means of a wireless communications link 312. The communications circuitry 334 receives signals representing downlink data transmitted by the radio network part 301 on the wireless communications link 312 and transmits signals representing the downlink data via the wireless communications link 314 providing a wireless access interface for the communications device 306. Similarly, the communications circuitry 334 receives signals representing uplink data transmitted by the communications device 306 via the wireless communications link 314 and transmits signals representing the uplink data to the ground station 330 on the wireless communications link 312. The wireless communications links 312, 314 may operate at a same frequency, or may operate at different frequencies.

The extent to which the communications circuitry 334 processes the received signals depends on the processing capability of the communications circuitry 334 as explained in more detail with reference to FIGS. 5 and 6 below.

FIG. 5 illustrates an example of an NTN architecture based on the NTN aerial vehicle 310 operating in a transparent manner, meaning that a signal received from the communications device 306 at the NTN aerial vehicle 310 is forwarded (to the communications device 306, to the ground station 330 on Earth or to another NTN aerial vehicle) with only frequency conversion and/or amplification. In such implementations, a wireless access interface (such as an NR Uu interface) is provided by the base station 332 located on the Earth for communications with the communications device 306. In such implementations, the base station 332 may be regarded as “NTN infrastructure equipment”.

FIG. 6 illustrates an example of an NTN architecture where the communications circuitry 334 of the NTN aerial vehicle 310 implements at least some base station functionality. In such cases, the NTN aerial vehicle 310 acts as “NTN infrastructure equipment” for the communications device 306 located in the coverage area 308 provided by the beam generated by the communications circuitry 334 of the NTN aerial vehicle 310. In such implementations, the communications circuitry 334 generates the wireless access interface (such as an NR Uu interface) which connects the NTN aerial vehicle 310 and the communications device 306. For example, the communications circuitry 334 may decode a received signal, and encode and generate a transmitted signal. In other words, the communications circuitry 334 may include some or all of the functionality of a base station (such as a gNodeB or eNodeB). In some examples, latency-sensitive functionality (such as acknowledging a receipt of the uplink data, or responding to a RACH request) may be performed by the communications circuitry 334 partially implementing some of the functions of a base station. A wireless communications feeder link between the NTN aerial vehicle 310 and the ground station 330 may provide connectivity between the communications circuitry 334 and the core network part 302. In scenarios where the NTN aerial vehicle 310 implements at least some base station functionality, the base station 332 located on the Earth may not be present in the NTN 300.

### Inter-Cell and Intra-Cell Mobility Procedures

Although FIG. 4 illustrates an NTN aerial vehicle 310 generating a single beam providing a coverage area 308 for the communications device 306, it will be appreciated by one skilled in the art that NTN aerial vehicles may be configured to generate a plurality of beams each of which provides a respective coverage area for the communications device 306. In such cases, the coverage area provided by each beam may or may not belong to the same communications cell.

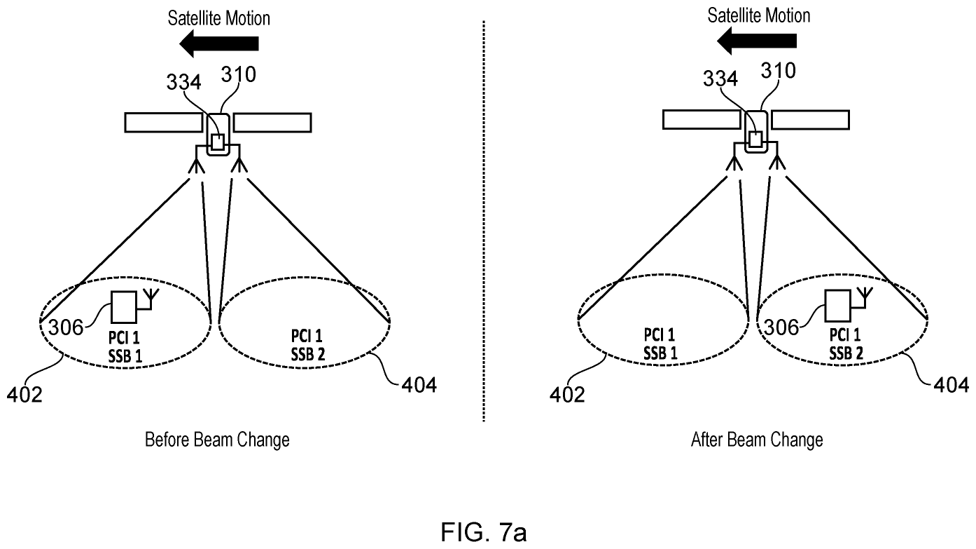

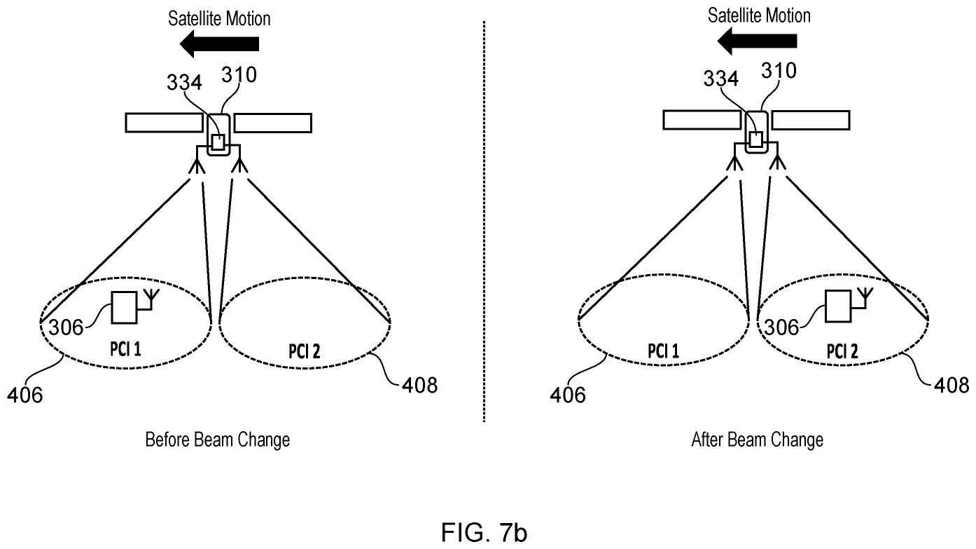

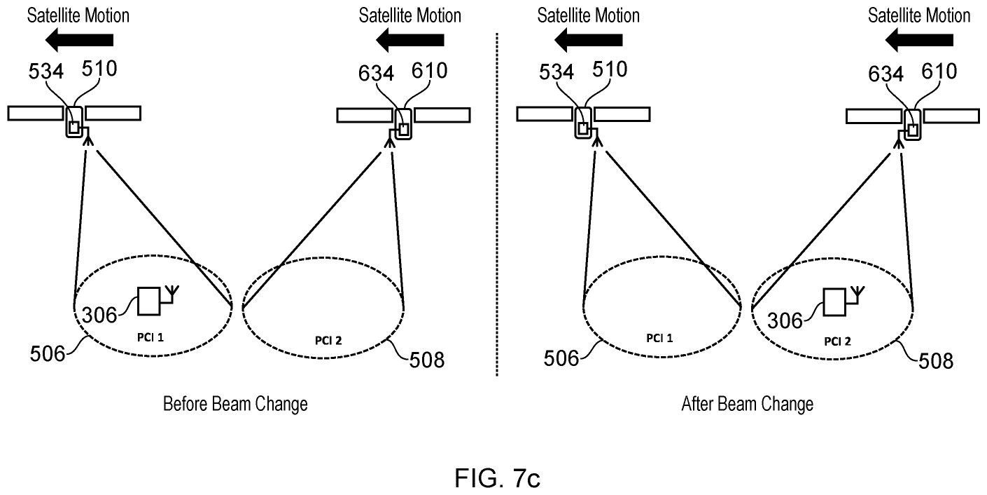

In Release-15 of the 3GPP standards, procedures were introduced for “intra-cell mobility”. Intra-cell mobility procedures include intra-cell beam mobility procedures for a communications device between different beams forming part of the same communications cell. An example of intra-cell mobility is now described with reference to FIG. 7a. As shown in FIG. 7a, the NTN aerial vehicle 310 is configured to generate a plurality of beams each of which provide a respective coverage area 402, 404 for the communications device 306. For example, the NTN aerial vehicle 310 may comprise a plurality of TRPs and transmit a beam from each TRP.

Although not shown in FIG. 7a for clarity, the NTN aerial vehicle 310 is connected to a radio network part and a core network part (such as the radio network part 301 and the core network part 302 shown in FIG. 4). The NTN aerial vehicle 310 may operate in a transparent manner (such as that described with reference to FIG. 5) or the NTN aerial vehicle 310 may implement at least some base station functionality (such as that described with reference to FIG. 6).

As shown in FIG. 7a, a first of the plurality of beams is associated with a first physical cell identity (PCI 1) and a first synchronisation signal block (SSB 1) while a second of the plurality of beams is associated with PCI 1 and a second SSB (SSB 2). Since both of the plurality of beams are associated with the same PCI, then the plurality of beams form part of the same communications cell. As the NTN aerial vehicle 310 moves as part of its orbit, the communications device 306 leaves the coverage area 402 provided by the first beam and enters the coverage area 404 provided by the second beam. Alternatively, the NTN aerial vehicle 310 may be geo-stationary and the communications device 306 moves between the first beam and the second beam. For example, the communications device 306 may be moving and the NTN aerial vehicle 310 may be stationary or the NTN aerial vehicle 310 has steerable beams that point to the same location area on the Earth. Such intra-cell mobility can be controlled by conventional beam mobility procedures.

In Release-17 of the 3GPP standards, procedures were introduced for “inter-cell mobility”. Inter-cell mobility procedures include RRC layer cell mobility procedures and lower layer beam mobility procedures for a communications device between different beams forming part of different communications cells. Examples of inter-cell mobility are illustrated in FIGS. 7b and 7c.

As shown in FIG. 7b, the NTN aerial vehicle 310 is configured to generate a plurality of beams each of which provide a respective coverage area 406, 408 for the communications device 306. For example, the NTN aerial vehicle 310 may comprise a plurality of TRPs and transmit a beam from each TRP.

Although not shown in FIG. 7b for clarity, the NTN aerial vehicle 310 is connected to a radio network part and a core network part (such as the radio network part 301 and the core network part 302 shown in FIG. 4). The NTN aerial vehicle 310 may operate in a transparent manner (such as that described with reference to FIG. 5) or the NTN aerial vehicle 310 may implement at least some base station functionality (such as that described with reference to FIG. 6).

A first of the plurality of beams is associated with a first physical cell identity (PCI 1) while a second of the plurality of beams is associated with a second PCI (PCI 2). Since the first beam 406 and the second beam are associated with different PCIs, then the first beam and the second beam form part of different communications cells. As the NTN aerial vehicle 310 moves as part of its orbit, the communications device 306 leaves the coverage area 406 provided by the first beam 406 and enters the coverage area 408 provided by the second beam. In other words, the communications device 306 may be handed over from the first beam to the second beam. Alternatively, the NTN aerial vehicle 310 may be geo-stationary and the communications device 306 may move between the first beam and the second beam. For example, the communications device 306 may be moving and the NTN aerial vehicle 310 may be stationary or the NTN aerial vehicle 310 has steerable beams that point to the same location area on the Earth. Since the first beam and the second beam form part of different communications cells, then inter-cell mobility procedures include RRC layer cell mobility procedures and lower layer beam mobility procedures. Such inter-cell mobility procedures may be referred to as “inter-cell beam management (ICBM) procedures”.

Now referring to FIG. 7c, a first NTN aerial vehicle 510 and a second aerial vehicle 610 are provided. Communications circuitry 534 of the first NTN aerial vehicle 510 generates a first beam providing a coverage area 506 for the communications device 306 and communications circuitry 634 of the second NTN aerial vehicle generates a second beam providing a coverage area 508 for the communications device 306. For example, the first NTN aerial vehicle 510 and the second aerial vehicle 610 may each comprise a TRP and transmit a beam from the TRP.

Although not shown in FIG. 7c for clarity, each of the first and second NTN aerial vehicles 510, 610 are connected to a radio network part and a core network part (such as the radio network part 301 and the core network part 302 shown in FIG. 4). The first and second NTN aerial vehicles 510, 610 may operate in a transparent manner (such as that described with reference to FIG. 5) or the first and second NTN aerial vehicles 510, 610 may implement at least some base station functionality (such as that described with reference to FIG. 6).

The first beam is associated with a first physical cell identity (PCI 1) while the second beam is associated with a second PCI (PCI 2). Since the first beam and the second beam are associated with different PCIs, then the first beam and the second beam form part of different communications cells. As the first and second NTN aerial vehicles 510, 610 move as part of their orbit, the communications device 306 leaves the coverage area 506 provided by the first beam and enters the coverage area 508 provided by the second beam. In other words, the communications device 306 may be handed over from the first beam to the second beam. Alternatively, the first and second NTN aerial vehicles 510, 610 may be geo-stationary and the communications device 306 may move between the first beam and the second beam. For example, the communications device 306 may be moving and the first and second NTN aerial vehicles 510, 610 may be stationary or the NTN aerial vehicles 510, 610 have steerable beams that point to the same location area on the Earth. Since the first beam and the second beam form part of different communications cells, then inter-cell mobility procedures include RRC layer cell mobility procedures and lower layer beam mobility procedures. Such procedures may be referred to as “inter-cell beam management (ICBM) procedures”.

Beam mobility procedures (intra-cell or inter-cell) do not require explicit Radio Resource Control (RRC) signalling to be triggered. For ICBM, a communications device can receive or transmit dedicated channels/signals via a TRP transmitting a beam associated with a PCI different from the PCI of a serving cell, while non-dedicated channels/signals can only be received via a TRP transmitting a beam associated with a PCI of the serving cell. A gNB (for example, base station 332 or NTN aerial vehicle 310) provides, via RRC signalling, the communications device with measurement configurations comprising configurations of SSB/CSI resources and resource sets, reports and trigger states for triggering channel and interference measurements and reports. For ICBM, a measurement configuration includes SSB resources associated with PCIs different from the PCI of a serving cell. Beam mobility procedures are then dealt with at lower layers by means of physical layer and MAC layer control signalling, and the RRC layer is not required to be aware of which beam is being used at a given point in time. However, as mentioned above, existing inter-cell mobility procedures include cell mobility procedures which involve RRC layer signalling.

It has been agreed, in Release-17 of the 3GPP standards, that both intra-cell and inter-cell mobility procedures should be supported. It has furthermore been agreed that the decision of whether the satellite footprint can be a cell or beams should be left to the operator's implementation.

### Transmission Configuration Indicator (TCI)

In Release-15 of the 3GPP standards, a transmission configuration indicator (TCI) was introduced to configure a communications device with one or more TCI states associated with a particular communications cell. As will be understood by one skilled in the art, each TCI state is associated with a different beam. Therefore, the terms “TCI state” and “beam” will be used interchangeably.

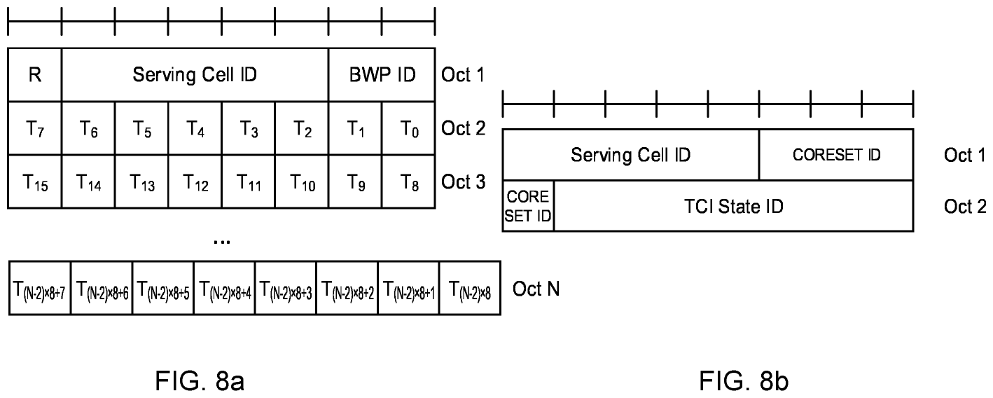

For example, for PDSCH, a list of up to 128 TCI states can be configured for a communications device (for example, via RRC signalling). After the communications device is configured with the TCI states, it subsequently receives a Medium Access Control (MAC) Control Element (CE) to semi-statically activate up to 8 of the TCI states simultaneously. The communications device can then use one of the activated TCI states to receive the PDSCH. For example, the communications device may measure the availability of the 8 activated beams (i.e. whether any of the 8 beams have failed or not), and the gNB indicates dynamically via PDCCH which beam/TCI state to receive PDSCH at a given time (i.e. instantaneously). In other words, the communications device uses a beam corresponding to one of the activated TCI states to receive the PDSCH. An example of a MAC CE for PDSCH is illustrated in FIG. 8a which has been reproduced from [3], the contents of which are hereby incorporated by reference in their entirety. As shown in FIG. 8a, the MAC CE comprises an R field, a serving cell ID field, a BWP ID field, and a plurality of Tᵢ fields. The fields of the MAC CE illustrated in FIG. 8a are explained below:
Serving Cell ID: This field indicates an identity of a serving cell for which the MAC CE applies. The length of the field is 5 bits;
BWP ID: This field indicates a downlink bandwidth part (DL BWP) for which the MAC CE applies as the codepoint of a bandwidth part indicator field (specified in [4]). The length of the BWP ID field is 2 bits;
Tᵢ: This field indicates the activation status of the list of TCI states previously configured for the communications device. T₀ refers to the first TCI state within the list, T₁ to the second one and so on. If the list of TCI states does not contain entry with index i, a MAC entity shall ignore the Tᵢ field. The Tᵢ field is set to 1 to indicate that the TCI state i shall be mapped to the codepoint of a DCI CSI request field. The codepoint to which the TCI state is mapped is determined by its ordinal position among all the TCI states with Tᵢ field set to 1, i.e. the first TCI state with Tᵢ field set to 1 shall be mapped to the codepoint value 1, second TCI state with Tᵢ field set to 1 shall be mapped to the codepoint value 2 and so on.
R: Reserved bit, set to 0.

For PDCCH, up to 64 TCI states can be configured for a communications device (for example, via RRC signalling). After the communications device is configured with the TCI states, it subsequently receives a MAC CE to semi-statically activate one of the TCI states. The communications device can then use the activated TCI state to receive the PDCCH. In other words, the communications device uses the beam corresponding to the activated TCI state to receive the PDCCH. An example of a MAC CE for PDCCH is illustrated in FIG. 8b which has been reproduced from [3]. As shown in FIG. 8b, the MAC CE comprises a serving cell ID field, a plurality of CORESET ID fields and a TCI state ID field. The fields of the MAC CE illustrated in FIG. 8b are explained below:
Serving Cell ID: This field indicates an identity of a serving cell for which the MAC CE applies. The length of the field is 5 bits. If the indicated serving cell is configured as part of a simultaneousTCI-UpdateList1 or simultaneousTCI-UpdateList2 as specified in [5], this MAC CE applies to all serving cells in the set simultaneousTCI-UpdateList1 or simultaneousTCI-UpdateList2, respectively;
CORESET ID: This field indicates a Control Resource Set identified with ControlResourceSetId as specified in [5], for which the TCI State is being indicated. In case the value of the field is 0, the field refers to the Control Resource Set configured by controlResourceSetZero as specified in [5]. The length of the field is 4 bits;
TCI State ID: This field indicates the TCI state identified by TCI-StateId as specified in [5] applicable to the Control Resource Set identified by CORESET ID field. If the field of CORESET ID is set to 0, this field indicates a TCI-StateId for a TCI state of the first 64 TCI-states configured by tci-StatesToAddModList and tci-StatesToReleaseList in the PDSCH-Config in the active BWP. If the field of CORESET ID is set to the other value than 0, this field indicates a TCI-StateId configured by tci-StatesPDCCH-ToAddList and tci-StatesPDCCH-ToReleaseList in the controlResourceSet identified by the indicated CORESET ID. The length of the field is 7 bits.

Intra-cell mobility procedures have been proposed in which a time stamp is associated with each TCI state in a MAC CE (such as Tᵢ and TCI State ID illustrated in FIGS. 8a and 8b), and the communications device activates a TCI state based on the time stamp associated with the TCI state (see [6], the contents of which are hereby incorporated by reference in their entirety). However, such intra-cell mobility procedures are limited in that the time stamp only indicates a single timestamp corresponding to a time when a beam corresponding to the TCI state is expected to cover the communications device-the communications device activates the TCI state when the time indicated by the time stamp has been reached. Then, when the communications device determines that a later time corresponding to a later timestamp has been reached, the communications device activates a TCI state associated with the later timestamp, and deactivates the previously active TCI state. Furthermore, the use of a time stamp is based on the assumption that the motion of the beam providing the coverage area and/or the communications device is predictable. However, if the motion of a communications device/beam is not predictable, then it is not possible to determine a time stamp corresponding to a time when the communications device is in a coverage area provided by the beam. Additionally, as will be understood by one skilled in the art, the MAC CE elements described with reference to FIGS. 8a and 8b do not support inter-cell mobility because the TCI state ID(s) in the MAC CEs relate to the same serving cell. Existing inter-cell mobility procedures include cell mobility procedures which include higher layer RRC signalling which leads to increased latency and control signalling. Therefore, there is a need for improved inter-cell and intra-cell mobility procedures.

In view of the above, there is provided a method of operating a communications device to perform an intra-cell or inter-cell mobility procedure with a non-terrestrial network, NTN. The method comprises receiving, from the NTN, an indication of a plurality of beams belonging to the same or different communications cells provided by the NTN. For example, the plurality of beams may include a plurality of beams belonging to the same communications cell provided by the NTN or the plurality of beams may include one or more beams belonging to a first communications cell provided by the NTN and one or more beams belonging to a second, different communications cell provided by the NTN. The method comprises receiving, from the NTN, a condition for activating each of the plurality of beams for communications between the communications device and the NTN. That is, communication on the uplink from the communications device to the NTN and/or communication on the downlink from the NTN to the communications device. The method comprises determining that the condition is being met for at least one of the beams. The method comprises activating the at least one beam for communications between the communications device and the NTN for as long as the condition is being met. The condition comprises at least one of: a time period condition for each of the plurality of beams indicating a time period during which the respective beam should be active for communications between the communications device and the NTN; and a location range condition for each of the plurality of beams indicating a location range for the communications device during which the respective beam should be active for communications between the communications device and the NTN.

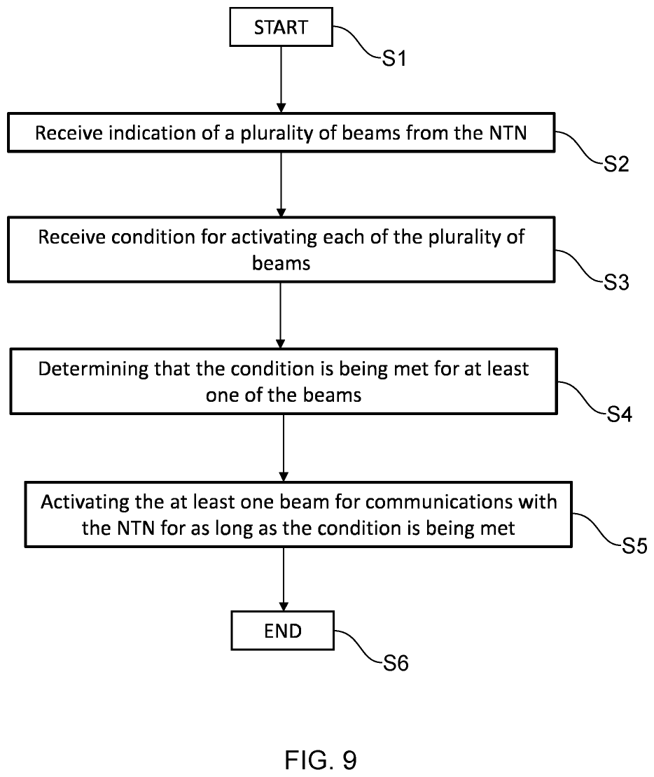

An example method of operating a communications device to perform an intra-cell or inter-cell mobility procedure with an NTN will now be described with reference to FIG. 9.

Referring to FIG. 9, the method starts in step 1.

In step 2, the communications device receives from the NTN, an indication of a plurality of beams belonging to the same or different communications cells provided by the NTN.

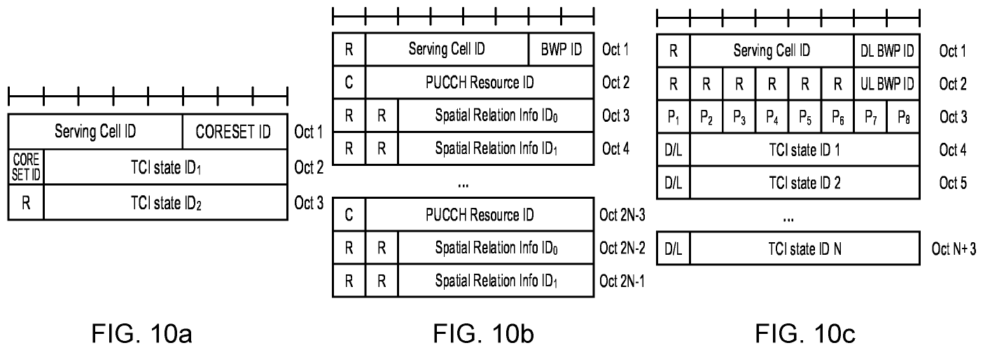

In some embodiments, the indication of the plurality of beams is received in a MAC CE from the NTN. The MAC CE may correspond to one of the MAC CEs shown in FIGS. 10a, 10b and 10c as will be described in more detail below.

In some embodiments, the indication of the plurality of beams is a TCI state for each of the plurality of beams. In some embodiments, the TCI states are a sub-set of a plurality of TCI states pre-configured for the communications device. For example, the communications device may be configured with the plurality of TCI states via an RRC signal in advance of receiving the indication of the sub-set of TCI states.

In step 3, the communications device receives, from the NTN, a condition for activating each of the plurality of beams for communications between the communications device and the NTN. The communications are, for example, uplink transmissions from the communications device to the NTN and/or downlink transmissions from the NTN to the communications device.

The condition comprises at least one of a time period condition for each of the plurality of beams indicating a time period during which the respective beam should be active for communications between the communications device and the NTN and a location range condition for each of the plurality of beams indicating a location range for the communications device during which the respective beam should be active for communications between the communications device and the NTN. The time period condition and/or the location range condition are determined for the communications device based on a location of the communications device. For example, the communications device may transmit location information identifying a location of the communications device to the NTN. The NTN may use this information to determine the location and/or time period condition for the communications device. In some embodiments, the time and/or location range condition for each of the plurality of beams are determined by the NTN based on the received location information and based on ephemeris information of an NTN aerial vehicle which provides the respective beam to the communications device. In some embodiments, the time and/or location range condition for each of the plurality of beams are determined such that the communications device will activate the respective beam while the communications device is located in a coverage area provided by that beam.

In some embodiments, the communications device determines that the condition is no longer being met for the at least one beam, and, in response, deactivates the at least one beam for communications between the communications device and the NTN.

In some embodiments, the time period for each condition may indicate a start time and an end time. For example, the time period condition for each of the plurality of beams may adopt the following form: T₁ (start time): T₂ (start time+time period).

In some embodiments, the MAC CE which indicates the plurality of beams also comprises the condition for activating each of the plurality of beams for communications between the communications device and the NTN. In such embodiments, steps 2 and 3 are referring to the reception of the same MAC CE. Alternatively, the condition for activating each of the plurality of beams may be received in an RRC signal from the NTN. In such embodiments, the RRC signal may be received before or after the MAC CE. Therefore, step 2 may be performed before step 3, or step 3 may be performed before step 2.

The condition is determined by the NTN. In some embodiments, the time period condition and/or the location range condition may be determined by the NTN based on a determined location of the communications device. In some embodiments, the NTN receives location information from the communications device identifying a location of the communications device and uses the location information to determine the time period and/or location range condition. For example, the NTN may determine the time period and/or location range based on the location of the communications device and ephemeris information of an NTN aerial vehicle which provides a beam for the communications device. In one example, an NTN aerial vehicle provides a beam for a communications device and, based on the communications device location and the ephemeris information of the NTN aerial vehicle, determines a time period during which the communications device is expected to be in a coverage area provided by the beam. The NTN aerial vehicle may set the time period in the condition for activating the beam as the time period, or a sub-period of the time period, during which the communications device is expected to be in the coverage area provided by the beam. In another example, the NTN aerial vehicle provides a beam for a communications device and, based on the communications device location and the ephemeris information of the NTN aerial vehicle, determines a location range during which the communications device is expected to be in a coverage area provided by the beam. The NTN aerial vehicle may set the location range in the condition for activating the beam as the location range, or a sub-range of the location range, during which the communications device is expected to be in the coverage area provided by the beam.

In some cases, a communications device may not be willing to share its location and therefore does not report its location to the NTN (for example, because of privacy concerns). However, the NTN may acquire the location of the communications device by one or more of the following methods:
The NTN may acquire the location of the communications device from a location management function (LMF).
The NTN may estimate the location of the communications device based on a radio link quality report (for example, pathloss) received from the communications device.
The NTN may send a reference signal for the communications device to measure and the communications device will report assistance information (such as an assistance signal from which the NTN can determine a time difference between the reference signal and the assistance signal). The NTN can then calculate the location of the communications device based on the assistance information.
The NTN may verify the location of the communications device with respect to inter frequency/Radio access technology (RAT) measurements.

In step 4, the communications device determines that the condition is being met for at least one of the beams.

In some embodiments, the communications device determines that the time period condition is being met for the at least one beam. For example, the communications device may: identify a current time; identify, from the time period condition, a start time of the time period during which the at least one beam should be active for communications between the communications device and the NTN, identify, from the time period condition, an end time of the time period during which the at least one beam should be active for communications between the communications device and the NTN; and determine that the current time is equal to or later than the start time and earlier than the end time.

In some embodiments, the communications device determines that the location range condition is being met for the at least one beam. For example, the communications device may: determine a current location of the communications device; identify a reference location from the location range condition; determine a distance between the current location of the communications device and the reference location; and determine that the distance between the current location of the communications device and the reference location is within the distance range. In some embodiments, the reference location is a current location of an NTN aerial vehicle which provides the beam for which the condition is being met. The reference location is not limited and may be, for example, a centre of the cell or a centre of a beam.

In some embodiments, the communications device determines that the time and location range condition are being met for at least one of the beams. In other words, in some embodiments, both the time and the location beam must be met for the at least one beam for the communications device to activate the beam for communications between the communications device and the NTN.

In step 5, the communications device activates the at least one beam for communications between the communications device and the NTN for as long as the condition is being met. In other words, the communications activates, and keeps the at least one beam active, while the condition is being met. In some embodiments, the communications device may activate the at least one beam (and keep it active) for the duration of the time period during which the at least one beam should be active. In some embodiments, the communications device may activate the at least one beam (and keep it active) while the communications device is in the location range for the communications device during which the at least one beam should be active. In some embodiments, the communications device may activate the at least one beam (and keep it active) for as long as a current location of the communications device is within the location range for the at least one beam and a current time is within the time period for the at least one beam.

In step 6, the method ends.

Embodiments can provide improved inter-cell and intra-cell mobility procedures. For example, by basing a condition for beam activation on a time period, increased flexibility can be provided in controlling inter-cell and intra-cell mobility. For example, the NTN can control how long each beam should be activated based on how long a communications device is expected to be located in a coverage area provided by the beam.

Furthermore, communications device power consumption can be reduced because the communications device only needs to keep the beam active for as long as the condition is being met. Furthermore, by basing a condition for beam activation on a location of the communications device, then power consumption can be reduced. For example, the NTN can ensure that a communications device only activates a beam when it is located in the coverage area provided by the beam. Furthermore, by basing a condition for beam activation on a location of the communications device, then increased flexibility can be provided in controlling inter-cell and intra-cell mobility. For example, using a location range condition means that the motion of the communications device does not need to be predictable with time to ensure that the communications device is located in a coverage area. In some embodiments, the condition is based on both the time period and location range condition. In such embodiments, the activation of a TCI state can be even more accurately controlled than if only the time period or the location range condition was used.

References to communications with an “NTN” include references to communications with one or more NTN aerial vehicles in the NTN. For example, one or more NTN aerial vehicles may provide the plurality of beams. In intra-cell mobility, the communications device may be currently served by a beam provided by an NTN aerial vehicle, and the condition is met for another beam provided by the same NTN. In inter-cell mobility, the communications device may be currently served by a first NTN aerial vehicle, and the condition is met for a another beam provided by a second, different NTN aerial vehicle.

Although FIG. 9 has been described with reference to a condition for activating each of the plurality of beams, in other embodiments, the condition may be for deactivating each of the plurality of beams. For example, the time period for each of the plurality of beams may be a time period during which the respective beam should be inactive for communications between the communications device and the NTN. Similarly, the location range for each of the plurality of beams may be a location range during which the respective beam should be inactive for the communications device. In one example, the time period for a beam may be a time period for which the NTN determines the communications device will be outside the coverage area for that beam. In one example, the location range for a beam may be a location range for the communications device for which the NTN determines the communications device will be outside the coverage area for that beam. In embodiments where the condition is for deactivating beams, the communications device may keep beams active until the condition for deactivating the beams have been met.

As mentioned above, the indication of the plurality of beams and the condition for activating or deactivating the plurality of beams may be transmitted by the NTN to the communications device in a MAC CE corresponding to one of the MAC CEs shown in FIGS. 10a, 10b and 10c. The MAC CEs shown in FIGS. 10a, 10b and 10c correspond to MAC CEs which have been enhanced as part of Release-17 of the 3GPP standards (herein after referred to as “enhanced MAC CEs”).

FIG. 10a illustrates an enhanced TCI state indication for a UE-specific MAC CE. As shown in FIG. 10a, the enhanced MAC CE is based on the MAC CE shown in FIG. 8b except that the enhanced MAC CE additionally comprises a reserved bit field and a plurality of TCI state ID fields. The fields in the enhanced MAC CE are as follows:
Serving Cell ID: This field indicates an identity of a serving cell for which the MAC CE applies.
CORESET ID: This field indicates a Control Resource Set identified with ControlResourceSetId as specified in [5], for which the TCI State is being indicated. In case the value of the field is 0, the field refers to the Control Resource Set configured by controlResourceSetZero as specified in [5].
TCI State IDᵢ: The TCI State ID₀ indicates TCI State for a first resource within the CORESET identified by the CORESET ID; TCI State ID₁ indicates TCI state for the second resource within the CORESET identified by the CORESET ID and so on.
R: Reserved bit, set to 0.

Since the MAC CE comprises a plurality of TCI state ID fields, then the MAC CE can indicate the TCI state ID for a plurality of beams. In accordance with example embodiments, the MAC CE may be adapted to associate each TCI state ID with a condition for activating that TCI state ID. The condition may be at least one of a time period and a location range condition as mentioned above. Therefore, the MAC CE can transmit a plurality of TCI state IDs identifying a plurality of beams along with a condition for activating each of the TCI state IDs/beams.

Furthermore, one or more of the TCI state IDs may be for a different cell than one or more of the other TCI state IDs. Therefore, the plurality of beams indicated by the NTN can include one or more beams from a different cell than a serving cell of the of the communications device. Therefore, if the communications device activates one of the beams of a different cell in response to determining that the condition for activating that beam is being met, then an inter-cell mobility procedure is triggered.

FIG. 10b illustrates PUCCH spatial relation activation/deactivation for multiple TRP PUCCH repetition enhanced MAC CE. As shown in FIG. 10b, the enhanced MAC CE comprises a plurality of reserved bits (R), a bandwidth part ID (BWP ID), a plurality of PUCCH resource IDs, and a plurality of spatial relation information IDs for each PUCCH resource ID. The fields of the enhanced MAC CE are as follows:
Serving Cell ID: This field indicates an identity of a serving cell for which the MAC CE applies.
BWP ID: This field indicates a downlink bandwidth part (DL BWP) for which the MAC CE applies as the codepoint of a bandwidth part indicator field (specified in [4]).
R: Reserved bit, set to 0.
PUCCH Resource ID: This field contains an identifier of the PUCCH resource ID identified by PUCCH-ResourceId as specified in [5], which is to be activated with a spatial relations indicated by Spatial Relation Info ID; fields in the subsequent octet(s). The length of the field is 7 bits. If the indicated PUCCH Resource ID is included in a PUCCH Resource Group (configured via resourceGroupToAddModList as specified in [5]) of the indicated UL BWP, no other PUCCH Resources within the same PUCCH Resource group are indicated in the MAC CE, and this MAC CE applies to all the PUCCH Resources in the PUCCH Resource group;
Spatial Relation Info IDᵢ: This field contains PUCCH-SpatialRelationInfoId-r16 where PUCCH-SpatialRelationInfoId is the identifier of the PUCCH Spatial Relation Info in PUCCH-Config in which the PUCCH Resource ID is configured, as specified in [5], where i is the index of the activated spatial relation info ID. The length of the field is 6 bits;

C: This field indicates whether single or two spatial relation info(s) is activated for the indicated PUCCH Resource ID. If this field is set to “1”, octet containing the second spatial relation info for the indicated PUCCH Resource is present. If this field is set to “0”, octet containing the second spatial relation info for the indicated PUCCH Resource is not present;

Since each beam can be identified by a spatial relation info ID field, and the MAC CE comprises a plurality of spatial relation info ID fields, then the MAC CE can indicate whether to activate a beam corresponding to each of the each of a plurality of beams. In accordance with example embodiments, the MAC CE may be adapted to associate each spatial relation info ID field with a condition for activating the beam corresponding to that spatial relation info ID field. The condition may be at least one of a time period and a location range condition as mentioned above.

FIG. 10c illustrates unified TCI state activation/deactivation enhanced MAC CE. As shown in FIG. 10c, the enhanced MAC CE comprises a plurality of reserved bits, a serving cell ID, a downlink bandwidth part ID (DL BWP ID), an uplink bandwidth part (ID) and a plurality of TCI state IDs. The fields of the MAC CE are as follows:
Serving Cell ID: This field indicates an identity of a serving cell for which the MAC CE applies.
DL BWP ID: This field indicates a downlink bandwidth part (DL BWP) for which the MAC CE applies as the codepoint of a bandwidth part indicator field (specified in [4]).
UL BWP ID: This field indicates a downlink bandwidth part (DL BWP) for which the MAC CE applies as the codepoint of a bandwidth part indicator field (specified in [4]).
TCI state ID N: This field indicates the activation status of the list of TCI states previously configured for the communications device. TCI state ID 1 refers to the first TCI state within the list, TCI state ID 2 to the second one and so on.
Pᵢ: This field indicates whether each TCI codepoint has multiple TCI states or single TCI state. If Pᵢ field set to 1, it indicates that ith TCI codepoint includes the DL TCI state and the UL TCI state. If Pi field set to 0, it indicates that ith TCI codepoint includes only the DL TCI state or the UL TCI state.
D/L: This field indicate whether the TCI state ID in the same octet is for joint/downlink or uplink TCI state. If this field is set to “1”, the TCI state ID in the same octet is for joint/downlink. If this field is set to “0”, the TCI state ID in the same octet is for uplink;
R: Reserved bit, set to 0.

Since the MAC CE comprises a plurality of TCI state ID fields, then the MAC CE can indicate the TCI state ID for a plurality of beams. In accordance with example embodiments, the MAC CE may be adapted to associate each TCI state ID with a condition for activating that TCI state ID. The condition may be at least one of a time period and a location range condition as mentioned above. Therefore, the MAC CE can transmit a plurality of TCI state IDs identifying a plurality of beams along with a condition for activating each of the TCI state IDs/beams.

By using an enhanced MAC CE to trigger the activation of a beam, latency can be reduced. For example, although RRC signalling may be used to pre-configure beams (for example, TCI states) for a communications device, the beams can be subsequently activated using an enhanced MAC CE. Since the MAC layer is lower than the RRC layer, transmitting the MAC CE leads can provide rapid activation of beams than if RRC signalling is used to activate the beams. Furthermore, by using an enhanced MAC CE to trigger the activation of a beam, inter-cell mobility can be supported. That is, the same enhanced MAC CE can be used to indicate the activation status of beams belonging to different communications cells. Since inter-cell mobility can be provided without the need for conventional RRC layer cell mobility procedures, control signalling overhead can be reduced.

In some embodiments, the MAC CEs described with reference to FIGS. 10a-c have a different eLCID in the MAC PDU subheader as compared with the MAC CEs described in FIGS. 8a and 8b. Therefore, the MAC CE in FIGS. 10a-c can be used to activate TCI states for different communications cells.

Therefore, embodiments can provide improvements to existing inter-cell and intra-cell mobility procedures. As will be appreciated, the advantages described herein a merely illustrative and the skilled person will appreciate other advantages even if not expressly mentioned.

### Multi-Panel UE Inter-Cell Mobility

As explained above, embodiments can provide improved inter-cell and intra-cell mobility. The introduction of inter-cell mobility is expected to create further technical challenges when coverage areas provided by two different NTN aerial vehicles overlap as will be explained in more detail below.

As will be known to one skilled in the art, a communications device may comprise a communications panel. The communications panel comprises a plurality of antenna elements for transmitting and receiving radio signals. A communications device may comprise one communications panel (known as a “single panel” communications device) or a plurality of communications panels (known as a “multi-panel communications device”). In the case of a multi-panel communications device, each of the panels comprise a plurality of antenna elements for transmitting and receiving radio signals.

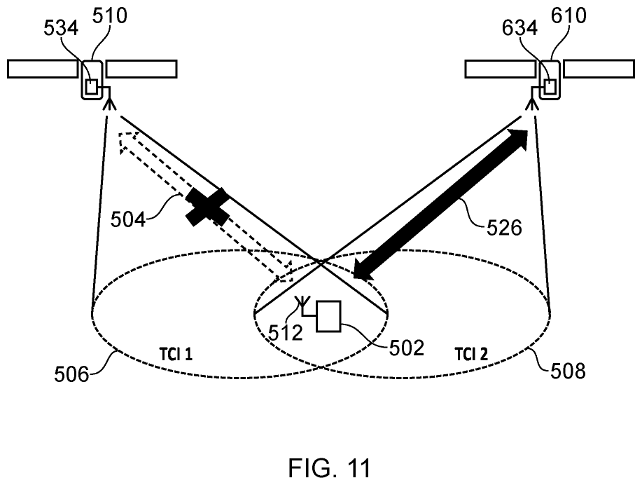

An example of an inter-cell mobility procedure for a single panel communications device is shown in FIG. 11. As shown in FIG. 11, the single panel communications device 502 is moving out of a coverage area 506 provided by a first beam (TCI 1) generated by a first NTN aerial vehicle 510 and into a coverage area 508 provided by a second beam (TCI) generated by a second NTN aerial vehicle 610. The change in coverage area may be caused by the movement of the first 510 and second 610 NTN aerial vehicles (for example, as they orbit the earth) and/or a movement of the single panel communications device 502. Since the single panel communications device 502 only has one panel 512, it can only steer one beam at a given time. Therefore, when the single panel communications device 502 is located in a region of overlap of the coverage area 506 provided by the first beam and the coverage area 508 provided by the second beam, it can only communicate via the first beam or the second beam but not both at the same time. As shown in FIG. 11, the single panel communications device 502 was communicating via the first beam (represented by arrow 504) and, at a later point, is instructed to switch over to communicate via the second beam (represented by arrow 526). In other words, the single panel communications device 502 deactivates the first beam for communications between the single panel communications device 502 and the first NTN aerial vehicle 510 and activates the second beam for communications between the single panel communications device 502 and the second aerial vehicle 610. Since the single panel communications device 502, must switch between the first and second beams while in the region of overlap, it may miss communications from the first NTN aerial vehicle 510 if it near the start of the region of overlap or from the second NTN aerial vehicle 610 near the end of the region of overlap.

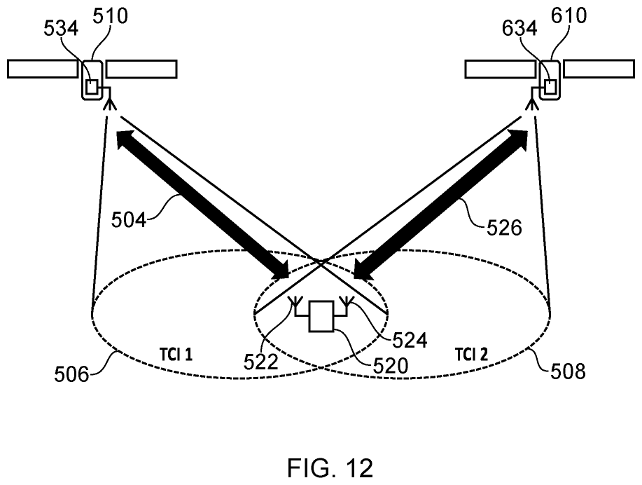

FIG. 12 illustrates an inter-cell mobility procedure for a multi panel communications device. As shown in FIG. 12, a multi panel communications device 520 is moving out of a coverage area 506 provided by a first beam (TCI 1) generated by a first NTN aerial vehicle 510 and into a coverage area 508 provided by a second beam (TCI) generated by a second NTN aerial vehicle 610. The change in coverage area may be caused by the movement of the first 510 and second 610 NTN aerial vehicles (for example, as they orbit the earth) and/or a movement of the multi panel communications device 520. Since the multi panel communications device 520 has two panels 522, 524, it can steer two beams simultaneously and independently. Therefore, when the multi panel communications device 520 is located in a region of overlap of the coverage area 506 provided by the first beam and the coverage area 508 provided by the second beam, it can communicate via the first beam and the second beam at the same time (as represented by arrows 504 and 526 respectively).

In accordance with example embodiments, the multi panel communications device 520 may be configured to determine that is a multi panel communications device 520. In response, the multi panel communications device 520 may modify the condition for activating the first beam by extending the time period during which the first beam should be active for communications between the communications device and the NTN and/or extending the location range during which the first beam should be active for communications between the communications device and the NTN. The extended time period and/or the extended location range overlap at least partially with the time period and/or the location range in the condition for activating the second beam.

Alternatively, the NTN may receive an indication from the communications device that it is a multi-panel communications device. In response, the NTN may modify the condition for activating the first beam by extending the time period during which the first beam should be active for communications between the communications device and the NTN and/or extending the location range during which the first beam should be active for communications between the communications device and the NTN. The extended time period and/or the extended location range overlap at least partially with the time period and/or the location range in the condition for activating the second beam.

Therefore, embodiments can increase the length of time for which the multi panel communications device communicates with both the first and second NTN aerial vehicle in the area of overlap, reducing the likelihood of the multi panel communications device missing communications from the NTN.

### Beam Failure Recovery

For beam failure detection in multi-TRP operation (see [7], the contents of which are hereby incorporated by reference in their entirety), a gNB (for example, base station 332 or NTN aerial vehicle 310) configures a communications device with a set of beam failure detection reference signals for each TRP.

For each set of beam failure detection reference signals, the communications device determines a number of beam failure instance indications at the physical layer. If the number of beam failure instance indications for a set of beam failure detection reference signals exceeds a pre-determined threshold within a pre-defined time period, then the communications device declares beam failure for the TRP associated with the set of beam failure detection reference signals.

In response to detecting beam failure for a TRP of a serving cell of the communications device, the communications device:
triggers beam failure recovery procedure by initiating transmission of a beam failure recovery (BFR) MAC CE for the TRP for which beam failure was declared;
selects a new beam (if available) for the TRP for which beam failure was declared;
indicates, in the BFR MAC CE for the TRP for which beam failure was declared, information about the beam failure and information about whether the selected beam has been successfully found or not.

Beam failure recovery is completed upon reception, at the communications device, of a PDCCH indicating an uplink grant. The uplink grant is for a new transmission of the HARQ process used for transmitting BFR MAC CE.

In cases where there are a plurality of TRPs in a Primary Cell (PCell), and the communications device detects beam failure for both of the TRPs, the beam failure recovery procedure is as follows:
The communications device triggers beam failure recovery by initiating a Random Access procedure on the PCell;
The communications device selects a new beam (if available) for each failed TRP;
The communications indicates, in the BFR MAC CE for each failed TRP, information about the beam failures and information about whether the selected beams have been successfully found or not.

Upon completion of the Random Access procedure, beam failure recovery for the failed TRPs of the PCell is considered complete.

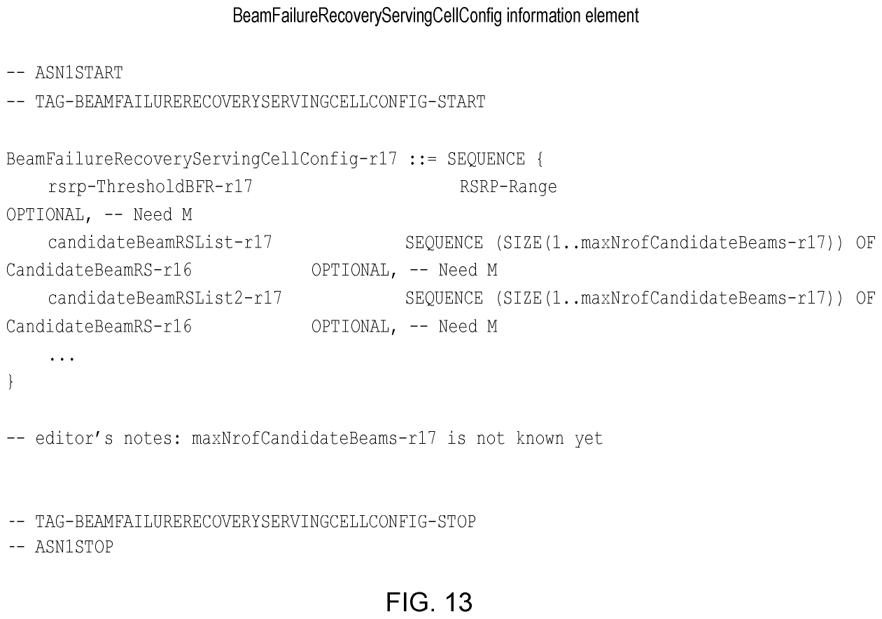

As explained above, existing beam failure recovery procedures involve the selection of a new beam after detecting of beam failure. Typically, the new beam is selected from a list of pre-configured candidate beams. For example, a communications device may receive an information element indicating a list of candidate beams for the communications device. An example of such an information element is shown in FIG. 13. The information element shown in FIG. 13 is a BeamFailureRecoveryServingCellConfig information element. The BeamFailureRecoveryServingCellConfig information element comprises an additionalPCI field, a candidateBeamRSList field, a candidatebeamRSlist 2 field and an rsrp-ThresholdBFR field. The definitions of the fields in the a BeamFailureRecoveryServingCellConfig information element are as follows:

### AdditionalPCI

Indicates the physical cell IDs (PCI) of the SSBs in the candidateBeamRSList2.

### CandidateBeamRSList, a CandidatebeamRSlist 2

A list of reference signals (CSI-RS and/or SSB) identifying the candidate beams for recovery. The network always configures this parameter in every instance of this IE.

### Rsrp-ThresholdBFR

L1-RSRP threshold used for determining whether a candidate beam may be included by the communications device in (enhanced) BFR MAC CE (see [8]). The network always configures this parameter in every instance of this IE.

In existing procedures, communications devices select a new beam from the list of candidate beams based on a link quality of the candidate beams. For example, the communications device may select the candidate beam with the best link quality. The “quality” of the link may be determined based on a reference signal received power (RSRP), a reference signal received quality (RSRQ), and/or a signal to interference plus noise ratio (SINR), for example. As mentioned above, when the communications device selects a new beam, it transmits a BFR MAC CE including an indication of the selected beam.

However, selecting the new beam based on link quality suffers from drawbacks, particularly when the communications device is frequently moving between beams. For example, although the selected beam may be the beam with the best link quality when selected, the communications device may move out of coverage of that beam shortly after selection. Therefore, beam failure may occur again and/or the communications device may have to perform an RRC layer cell mobility procedure to a different beam. Communications resources may be wasted by performing repeated beam failure recovery procedures and/or RRC layer cell mobility procedures in response to repeated beam failure detections. There is therefore a need for improved beam failure recovery procedures.

In view of the above, there is provided a method of operating a communications device to perform beam failure recovery with a non-terrestrial network, NTN. The method comprises receiving, from the NTN, a beam failure recovery configuration identifying one or more beams provided by the NTN as candidate beams for communications between the communications device and the NTN after beam failure. The beam failure recovery configuration comprises an indication of a time period for each of the one or more candidate beams during which the communications device is expected to be in a coverage area provided by the respective candidate beam. The method comprises determining that beam failure has occurred. The method comprises selecting one of the candidate beams for communications between the communications device and the NTN based on the indication of the time period for each of the one or more candidate beams. The method comprises transmitting, to the NTN, a control message indicating the selected beam.

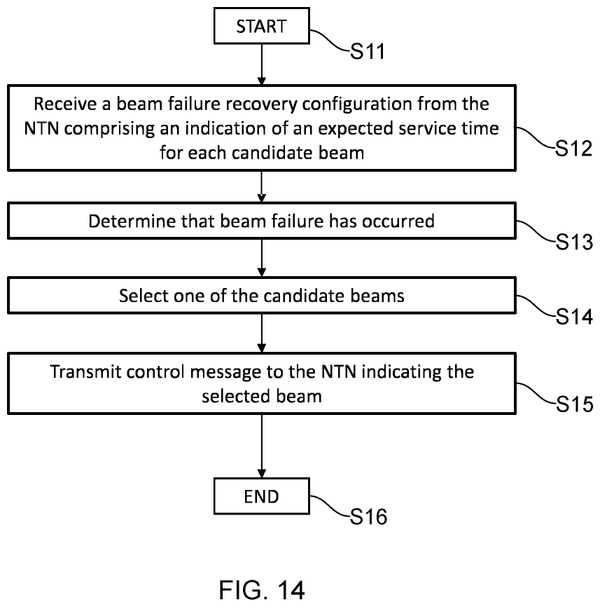

An example of a method of operating a communications device to perform beam failure recovery with an NTN will now be described with reference to FIG. 14. The method starts in step 11.

Referring to FIG. 14, in step 12, the communications device receives, from the NTN, a beam failure recovery configuration identifying one or more beams provided by the NTN as candidate beams for communications between the communications device and the NTN after beam failure. The beam failure recovery configuration comprises an indication of a time period for each of the one or more candidate beams during which the communications device is expected to be in a coverage area provided by the respective candidate beam. The time period for a beam may be alternatively referred to as the “expected service time” for the beam. The NTN may determine the expected service time for each beam based on ephemeris information of an NTN aerial vehicle which provides the respective beam. In some embodiments, the NTN receives location information identifying a location of the communications device and determines the expected service time for each beam based on the ephemeris information of the NTN aerial vehicle which provides that beam and the location information received from the communications device. In some embodiments, the beam failure recovery configuration corresponds to the beam failure recovery serving cell configuration information element shown in FIG. 13 adapted to include the service time for each of the candidate beams.

In step 13, the communications device determines that beam failure has occurred. For example, the communications device may receive a set of beam failure detection reference signals from the NTN and determine a number of beam failure instance indications at the physical layer. If the number of beam failure instance indications for the set of beam failure detection reference signals exceeds a pre-determined threshold within a pre-defined time period, then the communications device may declare beam failure.

In step 14, the communications device selects one of the candidate beams for communications between the communications device and the NTN based on the indication of the time period for each of the one or more candidate beams. In some embodiments, the communications device may determine, based on the indication of the time period for each of the one or more candidate beams, a remaining time period for which the communications device is expected to remain in a coverage area provided by the respective candidate beam. The remaining time period may alternatively be referred to as a “remaining service time”. In one example, the communications device may select the candidate beam which has the longest remaining service time.

For example, the communications device may determine a link quality for each of the one or more candidate beams, and select one of the candidate beams based on the indication of the time period for each of the one or more candidate beams and the determined link quality for each of the one or candidate beams. The determination of the link quality for each of the candidate beams may be based on an RSRP, RSRQ and/or SINR of the respective candidate beam.

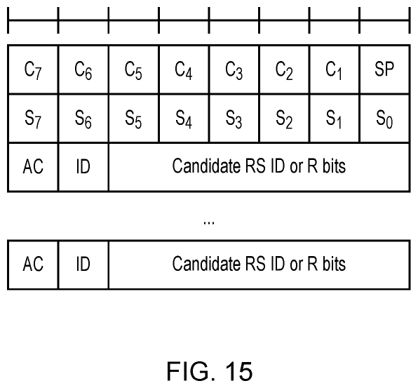

In step 15, the communications device transmits, to the NTN, a control message indicating the selected beam. In some embodiments, the communications device determines a location of the communications device and includes an indication of the location of the communications device in the control message transmitted to the NTN. For example, the indication of the location of the communications device may comprise Global Navigation Satellite System, GNSS, co-ordinates of the communications device. In some embodiments, the indication of the location of the communications device comprises a subset of the most significant bits of the GNSS co-ordinates of the communications device. As mentioned above, the communications device may transmit location information to the NTN for the NTN to determine the expected service time for the one or more candidate beams. In such embodiments, the indication of the location transmitted in the control message is an updated location of the communications device. Therefore, the NTN can evaluate whether or not the expected service time for the selected beam transmitted in the beam failure recovery configuration is still accurate for the communications device. In one example, the NTN may determine an updated expected service time for the selected beam based on the updated location of the communications device. The evaluation of the expected service time for the selected beam may comprise comparing the updated service time to the service time transmitted in the beam failure recovery configuration and scoring the result. The NTN may determine (based on the result of the evaluation) to calculate an updated service time for each of the one or more candidate beams and transmit the updated expected service time for the one or more candidate beams to the communications device in an updated beam failure recovery configuration. In such embodiments, the communications device may select an updated selected beam based on the updated beam failure recovery configuration and transmit an indication of the updated selected beam in an updated control message to the NTN. In some embodiments, the control message is an enhanced BFR MAC CE or a truncated enhanced BFR MAC CE such as described with reference to FIG. 15 below.

In step 16, the method ends.

Therefore, embodiments can provide a beam failure recovery configuration adapted to comprise an indication of an expected service time for each candidate beam and the communications device can select a candidate beam based on the expected service times. Accordingly, the communications device can select a more appropriate candidate beam to increase communications resource utilisation efficiency. For example, the communications device may select the candidate beam with the longest remaining service tie so as to minimising the number of RRC layer cell mobility procedures between different beams, thereby saving communications resources. In some embodiments, the communications device can select the candidate beam which has the best balance of link quality and remaining service time to reduce communications resource utilisation while simultaneously providing a strong connection to the NTN.

As mentioned above, the control message transmitted from the communications device to the NTN may be an example of an enhanced BFR MAC CE or a truncated enhanced BFR MAC CE is shown in FIG. 15. The enhanced BFR MAC CE and the truncated enhanced BFR MAC CE are described in detail in [2], the contents of which are hereby incorporated by reference in their entirety.

As shown in FIG. 15, the enhanced BFR MAC CE or truncated enhanced BFR MAC CE comprises a plurality of C fields, an SP field, a plurality of S fields, and a plurality of AC fields each associated with an ID field and a Candidate Reference Signal ID (or reserved bits) field. The fields in the enhanced BFR MAC CE or truncated enhanced BFR MAC CE are defined as follows:
SP (Enhanced BFR MAC CE): This field indicates beam failure detection for the SpCell (primary serving cell) of this MAC entity and the presence of octet(s) containing the AC field if the SpCell is configured with multiple BFD-RS sets. For the SpCell configured with two BFD-RS sets, this field set to 1 indicates that beam failure is detected for at least one BFD-RS set, the evaluation of the candidate beams according to the requirements as specified in [9] has been completed, and the octet(s) containing the AC field is present for the SpCell; otherwise, it is set to 0. The octet(s) containing the AC field for SpCell are included before those of SCell(s). For the SpCell not configured with multiple BFD-RS sets, the SP field is set to 1 to indicate that beam failure is detected for SpCell; otherwise, it is set to 0;
SP (Truncated Enhanced BFR MAC CE): This field indicates beam failure detection (as specified in clause 5.17) for the SpCell of this MAC entity. For the SpCell configured with two BFD-RS sets, this field set to 1 indicates that beam failure is detected for at least one BFD-RS set, the evaluation of the candidate beams according to the requirements as specified in [9] has been completed, and the octet(s) containing the AC field may be present for the SpCell; otherwise, it is set to 0. For the SpCell not configured with multiple BFD-RS sets, the SP field is set to 1 to indicate that beam failure is detected for SpCell; otherwise, it is set to 0;
Cᵢ (Enhanced BFR MAC CE): This field indicates beam failure detection (as specified in clause 5.17) and the presence of octet(s) containing the AC field for the SCell with ServCellIndex i as specified in [5]. The Cᵢ field set to 1 indicates that beam failure is detected for at least one BFD-RS set, the evaluation of the candidate beams according to the requirements as specified in [9] has been completed, and the octet(s) containing the AC field is present for the SCell with ServCellIndex i. The Cᵢ field set to 0 indicates that the beam failure is either not detected for any BFD-RS set or the beam failure is detected for at least one BFD-RS set but the evaluation of the candidate beams according to the requirements as specified in [9] has not been completed, and the octets containing the AC field is not present for the SCell with ServCellIndex i. The octets containing the AC field are present in ascending order based on the ServCellIndex and are included after the octets containing the AC field for SpCell, if any;
Cᵢ (Truncated Enhanced BFR MAC CE): This field indicates beam failure detection (as specified in clause 5.17) for the SCell with ServCellIndex i as specified in [5]. The Cᵢ field set to 1 indicates that beam failure is detected for at least one BFD-RS set, the evaluation of the candidate beams according to the requirements as specified in [9] has been completed, and the octet(s) containing the AC field for the SCell with ServCellIndex i may be present. The Cᵢ field set to 0 indicates that the beam failure is either not detected for any BFD-RS set or the beam failure is detected for at least one BFD-RS set but the evaluation of the candidate beams according to the requirements as specified in [9] has not been completed, and the octet(s) containing the AC field is not present for the SCell with ServCellIndex i;
Sₖ (Enhanced BFR MAC CE): This field corresponds to the k^{th} Serving Cell for which SP/Cᵢ field is set to 1 and is configured with two BFD-RS sets. The Serving Cells for which SP/Cᵢ field is set to 1 and are configured with two BFD-RS sets, are indexed sequentially starting with SpCell and followed by SCells in ascending order of ServCellIndex i. This field indicates whether beam failure is detected for one or both BFD-RS sets and presence of one or two octets containing the AC field of the Serving Cell. The Sₖ field set to 1 indicates that beam failure is detected for both the BFD-RS sets, the evaluation of the candidate beams according to the requirements as specified in [9] has been completed for both the BFD-RS sets, and the octets containing the AC field is present for both the BFD-RS sets, of the Serving Cell. The Sₖ field set to 0 indicates that beam failure is either detected for one of the BFD-RS sets and the evaluation of the candidate beams according to the requirements as specified in [9] has been completed or beam failure is detected for both the BFD-RS sets but the evaluation of the candidate beams according to the requirements as specified in [9] has not been completed for both the BFD-RS sets, and the octet containing the AC field is present for only one BFD-RS set of the Serving Cell. The Sₖ field not mapped to any Serving Cell is set to 0:
Sₖ (Truncated Enhanced BFR MAC CE): This field corresponds to the k^{th} Serving Cell for which SP/C; field is set to 1 and is configured with two BFD-RS sets. The Serving Cells for which SP/Cᵢ field is set to 1 and are configured with two BFD-RS sets, are indexed sequentially starting with SpCell and followed by SCells in ascending order of ServCellIndex i. This field indicates whether beam failure is detected for one or both BFD-RS sets of the Serving Cell. The Sₖ field set to 1 indicates that beam failure is detected for both the BFD-RS sets, the evaluation of the candidate beams according to the requirements as specified in [9] has been completed for both the BFD-RS sets, and the octet containing the AC field is present for zero, one or two BFD-RS sets of the Serving Cell. The Sₖ field set to 0 indicates that beam failure is either detected for one of the BFD-RS sets and the evaluation of the candidate beams according to the requirements as specified in [9] has been completed or beam failure is detected for both the BFD-RS sets but the evaluation of the candidate beams according to the requirements as specified in [9] has not been completed for both the BFD-RS sets or the octet containing the AC field is present for zero or one BFD-RS set of the Serving Cell. The Sₖ field not mapped to any Serving Cell is set to 0;
AC: This field indicates the presence of the Candidate RS ID field in this octet. If at least one of the SSBs with SS-RSRP above rsrp-ThresholdBFR amongst the SSBs in list of candidate beams (i.e. candidateBeamRSSCellList for the SCell not configured with two BFD-RS sets, candidateBeamresourceList or candidateBeamresourceList2 for Serving Cell configured with two BFD-RS sets) or the CSI-RSs with CSI-RSRP above rsrp-ThresholdBFR amongst the CSI-RSs in list of candidate beams is available, the AC field is set to 1; otherwise, it is set to 0. If the AC field set to 1, the Candidate RS ID field is present. If the AC field set to 0, R bits are present instead;
ID: This field indicates the identity of the BFD-RS set. It is set to 0 if this octet corresponds to BFD-RS set zero. It is set to 1 if this octet corresponds to BFD-RS set one. For the Serving cell not configured with two BFD-RS sets, this field is set to 0;
Candidate RS ID: This field is set to the index of an SSB with SS-RSRP above rsrp-ThresholdBFR amongst the SSBs in list of candidate beams (i.e. candidate BeamRSSCellList for the SCell not configured with two BFD-RS sets, candidate BeamresourceList or candidate BeamresourceList2 for Serving Cell configured with two BFD-RS sets) or to the index of a CSI-RS with CSI-RSRP above rsrp-ThresholdBFR amongst the CSI-RSs in the list of candidate beams. Index of an SSB or CSI-RS is the index of an entry in the list of candidate beams corresponding to the SSB or CSI-RS. Index 0 corresponds to the first entry in the list of candidate beams, index 1 corresponds to the second entry in the list and so on. The length of this field is 6 bits;
R: Reserved bit, set to 0.

In accordance with example embodiments, the enhanced or truncated enhanced BFR MAC CE is adapted to include an indication of the location of the communications device. For example, the enhanced or truncated enhanced BFR MAC CE may be adapted by adding a new element or field to include the indication of the location of the communications device. In some embodiments,, the indication of the location of the communications device may comprise GNSS co-ordinates of the communications device.

In some embodiments, the indication of the location of the communications device comprises a subset of the most significant bits of the GNSS co-ordinates of the communications device. Since the NTN is made aware of the location of the communications device (which may be an updated location as explained above), the NTN can evaluate the proper candidate beams for this UE based on the indication of the location of the communications device received in the BFR MAC CE and the expected service time for the candidate beam as explained above.

The following numbered paragraphs provide further example aspects and features of the present technique:

Paragraph 1. A method of operating a communications device to perform an intra-cell or inter-cell mobility procedure with a non-terrestrial network, NTN, the method comprising,
receiving, from the NTN, an indication of a plurality of beams belonging to the same or different communications cells provided by the NTN,
receiving, from the NTN, a condition for activating each of the plurality of beams for communications between the communications device and the NTN,
determining that the condition is being met for at least one of the plurality of beams,
activating the at least one beam for communications between the communications device and the NTN for as long as the condition is being met, wherein the condition comprises at least one of
a time period condition for each of the plurality of beams indicating a time period during which the respective beam should be active for communications between the communications device and the NTN, and
a location range condition for each of the plurality of beams indicating a location range for the communications device during which the respective beam should be active for communications between the communications device and the NTN.

Paragraph 2. A method according to paragraph 1, comprising
determining that the condition is no longer being met for the at least one beam, and, in response,
deactivating the at least one beam for communications between the communications device and the NTN.

Paragraph 3. A method according to paragraph 1 or paragraph 2, wherein the determining that the condition is being met for the at least one beam comprises
determining that the time period condition and the location range condition are being met for the at least one beam.

Paragraph 4. A method according to any of paragraphs 1 to 3, wherein the location range is a distance range of the communications device from a reference location.

Paragraph 5. A method according to paragraph 4, wherein the determining that the condition is being met comprises
determining a current location of the communications device,
identifying the reference location from the location range condition,
determining a distance between the current location of the communications device and the reference location, and
determining that the distance between the current location of the communications device and the reference location is within the distance range.

Paragraph 6. A method according to any of paragraphs 1 to 5, wherein the determining that the condition is being met comprises
determining a current time,
identifying, from the time period condition, a start time of the time period during which the at least one beam should be active for communications between the communications device and the NTN,
identifying, from the time period condition, an end time of the time period during which the at least one beam should be active for communications between the communications device and the NTN, determining that the current time is equal to or later than the start time and earlier than the end time.

Paragraph 7. A method according to any of paragraphs 1 to 6, comprising
determining a location of the communications device, and
transmitting location information to the NTN identifying the location of the communications device for the NTN to determine the time period condition and/or location range condition for the communications device.

Paragraph 8. A method according to any of paragraphs 1 to 6, comprising
transmitting a radio link quality report to the NTN for the NTN to determine location information identifying a location of the communications device, the location information being for the NTN to determine the time period condition and/or location range condition.

Paragraph 9. A method according to any of paragraphs 1 to 6, comprising
receiving a reference signal from the NTN, and in response,
transmitting an assistance signal to the NTN for the NTN to determine location information identifying a location of the communications device based on the reference signal and the assistance signal, the location information being for the NTN to determine the time period condition and/or location range condition.

Paragraph 10. A method according to any of paragraphs 1 to 9, wherein the receiving the indication of the plurality of beams provided by the NTN comprises
receiving the indication of the plurality of beams provided by the NTN in a medium access control, MAC, control element, CE.

Paragraph 11. A method according to paragraph 10, wherein the MAC CE comprises the condition for activating each of the plurality of beams for communications between the communications device and the NTN.

Paragraph 12. A method according to any of paragraphs 1 to 11, wherein the indication of the plurality of beams provided by the NTN is an indication of a transmission configuration indicator, TCI, state for each of the plurality of beams provided by the NTN.

Paragraph 13. A method according to paragraph 12, wherein the TCI states are a sub-set of a plurality of TCI states pre-configured for the communications device.

Paragraph 14. A method according to paragraph 13, wherein the plurality of pre-configured TCI states are configured by
receiving, from the NTN, a Radio Resource Control, RRC, signal indicating the plurality of pre-configured TCI states.

Paragraph 15. A method according to any of paragraphs 1 to 14, wherein the receiving the condition for activating the plurality of beams for communications between the communications device and the NTN comprises
receiving the condition for activating the plurality of beams for communications between the communications device and the NTN in a Radio Resource Control, RRC, signal.

Paragraph 16. A method according to any of paragraphs 1 to 15, wherein the plurality of beams provided by the NTN comprise
a first beam and a second beam, the first beam being the beam for which the condition is being met, and the method comprises
determining that the condition is no longer being met for the first beam, and, in response,
deactivating the first beam for communications between the communications device and the NTN,
determining that the condition for the second beam is being met, and in response,
activating the second beam for communications between the communications device and the NTN.

Paragraph 17. A method according to paragraph 16, wherein the first beam and the second beam belong to different communications cells provided by the NTN.

Paragraph 18. A method according to paragraph 17, comprising
determining that the communications device is a multi-panel communications device configured to communicate with the NTN via the first and second beams simultaneously, and, in response,
modifying the condition for activating the first beam by extending at least one of
the time period during which the first beam should be active for communications between the communications device and the NTN, and
the location range during which the first beam should be active for communications between the communications device and the NTN, the at least one of the extended time period and the extended location range overlapping at least partially with the time period or the location range in the condition for activating the second beam, wherein
the determining that the condition is no longer being met for the first beam comprises
determining that the modified condition is no longer being met for the first beam.

Paragraph 19. A method according to paragraph 17, comprising
determining that the communications device is a multi-panel communications device configured to communicate with the NTN via the first and second beams simultaneously, and, in response,
transmitting, to the NTN, an indication that the communications device is a multi-panel communications device.

Paragraph 20. A method according to paragraph 16, wherein the first beam and the second beam belong to the same communications cell provided by the NTN.

Paragraph 21. A method of operating infrastructure equipment of a non-terrestrial network, NTN, to perform an intra-cell or inter-cell mobility procedure with a communications device, the method comprising,
determining a condition for the communications device to activate each of a plurality of beams belonging to the same or different communications cells provided by the NTN for communications between the communications device and the NTN,
transmitting, to the communications device, an indication of the plurality of beams provided by the NTN,
transmitting, to the communications device, the condition for activating each of the plurality of beams for communications between the communications device and the NTN, wherein the condition comprises at least one of
a time period condition for each of the plurality of beams indicating a time period during which the respective beam should be active for communications between the communications device and the NTN, and
a location range condition for each of the plurality of beams indicating a location range for the communications device during which the respective beam should be active for the communications between the communications device and the NTN.

Paragraph 22. A method according to paragraph 21, wherein the determining the condition for the communications device to activate each of the plurality of beams comprises
receiving, from the communications device, location information identifying the location of the communications device,
determining the time period condition and/or the location range condition based on the location of the communications device identified by the location information.

Paragraph 23. A method according to paragraph 21, wherein the determining the condition for the communications device to activate each of the plurality of beams comprises
acquiring location information identifying a location of the communications device from a location management function, LMF,
determining the time period condition and/or the location range condition based on the location of the communications device identified by the location information.

Paragraph 24. A method according to paragraph 21, wherein the wherein the determining the condition for the communications device to activate each of the plurality of beams comprises
transmitting a reference signal to the communications device, and in response,
receiving an assistance signal from the communications device,
determining location information identifying the location of the communications device based on the reference signal and the assistance signal,
determining the time period condition and/or the location range condition based on the location of the communications device identified by the location information.

Paragraph 25. A method according to paragraph 21, wherein the determining the condition for the communications device to activate each of the plurality of beams comprises
receiving a radio link quality report from the communications device,
determining location information identifying a location of the communications device based on the radio link quality report,
determining the time period condition and/or the location range condition based on the location of the communications device identified by the location information.

Paragraph 26. A method according to any of paragraphs 21 to 25, comprising
verifying the determined location information based on one or more inter-frequency and/or radio access technology, RAT, measurements.

Paragraph 27. A method according to any of paragraphs 22 to 26, wherein the determining the condition for the communications device to activate each of the plurality of beams for communications between the communications device and the NTN comprises
determining the time period condition of each of the plurality of beams based on the location information and ephemeris information of an aerial vehicle of the NTN which provides the respective beam.

Paragraph 28. A method according to any of paragraphs 22 to 27, wherein the determining the condition for the communications device to activate each of the plurality of beams for communications between the communications device and the NTN comprises
determining the location range condition of each of the plurality of beams based on the location information and ephemeris information of an aerial vehicle of the NTN which provides the respective beam.

Paragraph 29. A method according to any of paragraphs 21 to 28, wherein the determining the condition for the communications device to activate each of the plurality of beams for communications between the communications device and the NTN comprises
determining that the condition comprises the time period condition and the location range condition.

Paragraph 30. A method according to any of paragraphs 21 to 29, wherein the determining the condition for the communications device to activate each of the plurality of beams for communications between the communications device and the NTN comprises
determining a reference location,
determining that the location range is a distance range of the communications device from the reference location.

Paragraph 31. A method according to any of paragraphs 21 to 30, wherein the determining the condition for the communications device to activate each of the plurality of beams for communications between the communications device and the NTN comprises
determining a start time for the time period during each of the plurality of beams should be active for communications between the communications device and the NTN, and
determining an end time for the time period during each of the plurality of beams should be active for communications between the communications device and the NTN.

Paragraph 32. A method according to any of paragraphs 21 to 31, wherein the transmitting the indication of the plurality of beams provided by the NTN comprises
transmitting the indication the indication of the plurality of beams provided by the NTN in a medium access control, MAC, control element, CE.

Paragraph 33. A method according to paragraph 32, wherein the MAC CE comprises the condition for activating each of the plurality of beams for communications between the communications device and the NTN.

Paragraph 34. A method according to any of paragraphs 21 to 33, wherein the indication of the plurality of beams provided by the NTN is an indication of a transmission configuration indicator, TCI, state for each of the plurality of beams provided by the NTN.

Paragraph 35. A method according to paragraph 34, wherein the TCI states are a sub-set of a plurality of TCI states pre-configured for the communications device.

Paragraph 36. A method according to paragraph 35, wherein the plurality of pre-configured TCI states are configured by
transmitting, to the communications device, a Radio Resource Control, RRC, signal indicating the plurality of pre-configured TCI states.

Paragraph 37. A method according to any of paragraphs 21 to 36, wherein the transmitting the condition for activating the plurality of beams for communications between the communications device and the NTN comprises
transmitting the condition for activating the plurality of beams for communications between the communications device and the NTN in a Radio Resource Control, RRC, signal.

Paragraph 38. A method according to any of paragraphs 21 to 37, wherein the plurality of beams provided by the NTN comprise
a first beam and a second beam belonging to different communications cells provided by the NTN.

Paragraph 39. A method according to paragraph 38, comprising
receiving, from the communications device, an indication that the communications device is a multi-panel communications device configured to communicate with the NTN via the first and second beam simultaneously, and in response,
modifying the condition for activating the first beam by extending at least one of
the time period during which the first beam should be active for communications between the communications device and the NTN, and
the location range during which the first beam should be active for communications between the communications device and the NTN, the at least one of the extended time period and the extended location range overlapping at least partially with the time period or the location range in the condition for activating the second beam.

Paragraph 40. A method according to any of paragraphs 21 to 37, wherein the plurality of beams provided by the NTN comprise
a first beam and a second beam belonging to the same communications cell provided by the NTN.

Paragraph 41. A method of operating a communications device to perform an intra-cell or inter-cell mobility procedure with a non-terrestrial network, NTN, the method comprising,
receiving, from the NTN, an indication of a plurality of beams belonging to the same or different communications cells provided by the NTN,
receiving, from the NTN, a condition for deactivating each of the plurality of beams for communications between the communications device and the NTN,
determining that the condition is being met for at least one of the plurality of beams,
deactivating the at least one beam for communications between the communications device and the NTN for as long as the condition is being met, wherein the condition comprises at least one of
a time period condition for each of the plurality of beams indicating a time period during which the respective beam should be inactive for communications between the communications device and the NTN, and
a location range condition for each of the plurality of beams indicating a location range for the communications device during which the respective beam should be inactive for communications between the communications device and the NTN.

Paragraph 42. A method according to paragraph 41, comprising
determining that the condition is no longer being met for the at least one beam, and, in response,
activating the at least one beam for communications between the communications device and the NTN.

Paragraph 43. A method according to paragraph 41 or paragraph 42, wherein the determining that the condition is being met for the at least one beam comprises
determining that the time period condition and the location range condition are being met for the at least one beam.

Paragraph 44. A method according to any of paragraphs 41 to 43, wherein the location range is a distance range of the communications device from a reference location.

Paragraph 45. A method according to paragraph 44, wherein the determining that the condition is being met comprises
determining a current location of the communications device,
identifying the reference location from the location range condition,
determining a distance between the current location of the communications device and the reference location, and
determining that the distance between the current location of the communications device and the reference location is within the distance range.

Paragraph 46. A method according to any of paragraphs 41 to 45, wherein the determining that the condition is being met comprises
determining a current time,
identifying, from the time period condition, a start time of the time period during which the at least one beam should be inactive for communications between the communications device and the NTN,
identifying, from the time period condition, an end time of the time period during which the at least one beam should be inactive for communications between the communications device and the NTN,
determining that the current time is equal to or later than the start time and earlier than the end time.

Paragraph 47. A method according to any of paragraphs 41 to 46, comprising
determining a location of the communications device, and
transmitting location information to the NTN identifying the location of the communications device for the NTN to determine the time period condition and/or location range condition for the communications device.

Paragraph 48. A method according to any of paragraphs 41 to 47, comprising
transmitting a radio link quality report to the NTN for the NTN to determine location information identifying a location of the communications device, the location information being for the NTN to determine the time period condition and/or location range condition.

Paragraph 49. A method according to any of paragraphs 41 to 48, comprising
receiving a reference signal from the NTN, and in response,
transmitting an assistance signal to the NTN for the NTN to determine location information identifying a location of the communications device based on the reference signal and the assistance signal, the location information being for the NTN to determine the time period condition and/or location range condition.

Paragraph 50. A method according to any of paragraphs 41 to 49, wherein the receiving the indication of the plurality of beams provided by the NTN comprises
receiving the indication of the plurality of beams provided by the NTN in a medium access control, MAC, control element, CE.

Paragraph 51. A method according to paragraph 50, wherein the MAC CE comprises the condition for deactivating each of the plurality of beams for communications between the communications device and the NTN.

Paragraph 52. A method according to any of paragraphs 41 to 51, wherein the indication of the plurality of beams provided by the NTN is an indication of a transmission configuration indicator, TCI, state for each of the plurality of beams provided by the NTN.

Paragraph 53. A method according to paragraph 52, wherein the TCI states are a sub-set of a plurality of TCI states pre-configured for the communications device.

Paragraph 54. A method according to paragraph 53, wherein the plurality of pre-configured TCI states are configured by
receiving, from the NTN, a Radio Resource Control, RRC, signal indicating the plurality of pre-configured TCI states.

Paragraph 55. A method according to any of paragraphs 41 to 54, wherein the receiving the condition for deactivating the plurality of beams for communications between the communications device and the NTN comprises
receiving the condition for deactivating the plurality of beams for communications between the communications device and the NTN in a Radio Resource Control, RRC, signal.

Paragraph 56. A method according to any of paragraphs 41 to 55, wherein the plurality of beams provided by the NTN comprise
a first beam and a second beam, the first beam being the beam for which the condition is being met, and the method comprises
determining that the condition is no longer being met for the first beam, and, in response,
activating the first beam for communications between the communications device and the NTN,
determining that the condition for the second beam is being met, and in response,
deactivating the second beam for communications between the communications device and the NTN.

Paragraph 57. A method according to paragraph 56, wherein the first beam and the second beam belong to different communications cells provided by the NTN.

Paragraph 58. A method according to paragraph 57, comprising
determining that the communications device is a multi-panel communications device configured to communicate with the NTN via the first and second beams simultaneously, and, in response,
modifying the condition for activating the first beam by extending at least one of
the time period during which the first beam should be inactive for communications between the communications device and the NTN, and
the location range during which the first beam should be inactive for communications between the communications device and the NTN, the at least one of the extended time period and the extended location range overlapping at least partially with the time period or the location range in the condition for deactivating the second beam, wherein
the determining that the condition is no longer being met for the first beam comprises
determining that the modified condition is no longer being met for the first beam.

Paragraph 59. A method according to paragraph 57, comprising
determining that the communications device is a multi-panel communications device configured to communicate with the NTN via the first and second beams simultaneously, and, in response,
transmitting, to the NTN, an indication that the communications device is a multi-panel communications device.

Paragraph 60. A method according to paragraph 56, wherein the first beam and the second beam belong to the same communications cell provided by the NTN.

Paragraph 61. A method of operating infrastructure equipment of a non-terrestrial network, NTN, to perform an intra-cell or inter-cell mobility procedure with a communications device, the method comprising,
determining a condition for the communications device to deactivate each of a plurality of beams belonging to the same or different communications cells provided by the NTN for communications between the communications device and the NTN,
transmitting, to the communications device, an indication of the plurality of beams provided by the NTN,
transmitting, to the communications device, the condition for deactivating each of the plurality of beams for communications between the communications device and the NTN, wherein the condition comprises at least one of
a time period condition for each of the plurality of beams indicating a time period during which the respective beam should be inactive for communications between the communications device and the NTN, and
a location range condition for each of the plurality of beams indicating a location range for the communications device during which the respective beam should be inactive for the communications between the communications device and the NTN.

Paragraph 62. A method according to paragraph 61, wherein the determining the condition for the communications device to deactivate each of the plurality of beams comprises
receiving, from the communications device, location information identifying the location of the communications device,
determining the time period condition and/or the location range condition based on the location of the communications device identified by the location information.

Paragraph 63. A method according to paragraph 61, wherein the determining the condition for the communications device to deactivate each of the plurality of beams comprises
acquiring location information identifying a location of the communications device from a location management function, LMF,
determining the time period condition and/or the location range condition based on the location of the communications device identified by the location information.

Paragraph 64. A method according to paragraph 61, wherein the wherein the determining the condition for the communications device to deactivate each of the plurality of beams comprises
transmitting a reference signal to the communications device, and in response,
receiving an assistance signal from the communications device,
determining location information identifying the location of the communications device based on the reference signal and the assistance signal,
determining the time period condition and/or the location range condition based on the location of the communications device identified by the location information.

Paragraph 65. A method according to paragraph 61, wherein the determining the condition for the communications device to deactivate each of the plurality of beams comprises
receiving a radio link quality report from the communications device,
determining location information identifying a location of the communications device based on the radio link quality report,
determining the time period condition and/or the location range condition based on the location of the communications device identified by the location information.

Paragraph 66. A method according to any of paragraphs 61 to 65, comprising
verifying the determined location information based on one or more inter-frequency and/or radio access technology, RAT, measurements.

Paragraph 67. A method according to any of paragraphs 62 to 66, wherein the determining the condition for the communications device to deactivate each of the plurality of beams for communications between the communications device and the NTN comprises
determining the time period condition of each of the plurality of beams based on the location information and ephemeris information of an aerial vehicle of the NTN which provides the respective beam.

Paragraph 68. A method according to any of paragraphs 62 to 67, wherein the determining the condition for the communications device to deactivate each of the plurality of beams for communications between the communications device and the NTN comprises
determining the location range condition of each of the plurality of beams based on the location information and ephemeris information of an aerial vehicle of the NTN which provides the respective beam.

Paragraph 69. A method according to any of paragraphs 61 to 68, wherein the determining the condition for the communications device to deactivate each of the plurality of beams for communications between the communications device and the NTN comprises
determining that the condition comprises the time period condition and the location range condition.

Paragraph 70. A method according to any of paragraphs 61 to 69, wherein the determining the condition for the communications device to deactivate each of the plurality of beams for communications between the communications device and the NTN comprises
determining a reference location,
determining that the location range is a distance range of the communications device from the reference location.

Paragraph 71. A method according to any of paragraphs 61 to 70, wherein the determining the condition for the communications device to deactivate each of the plurality of beams for communications between the communications device and the NTN comprises
determining a start time for the time period during each of the plurality of beams should be inactive for communications between the communications device and the NTN, and
determining an end time for the time period during each of the plurality of beams should be inactive for communications between the communications device and the NTN.

Paragraph 72. A method according to any of paragraphs 61 to 71, wherein the transmitting the indication of the plurality of beams provided by the NTN comprises
transmitting the indication the indication of the plurality of beams provided by the NTN in a medium access control, MAC, control element, CE.

Paragraph 73. A method according to paragraph 72, wherein the MAC CE comprises the condition for deactivating each of the plurality of beams for communications between the communications device and the NTN.

Paragraph 74. A method according to any of paragraphs 61 to 73, wherein the indication of the plurality of beams provided by the NTN is an indication of a transmission configuration indicator, TCI, state for each of the plurality of beams provided by the NTN.

Paragraph 75. A method according to paragraph 74, wherein the TCI states are a sub-set of a plurality of TCI states pre-configured for the communications device.

Paragraph 76. A method according to paragraph 75, wherein the plurality of pre-configured TCI states are configured by
transmitting, to the communications device, a Radio Resource Control, RRC, signal indicating the plurality of pre-configured TCI states.

Paragraph 77. A method according to any of paragraphs 61 to 76, wherein the transmitting the condition for deactivating the plurality of beams for communications between the communications device and the NTN comprises
transmitting the condition for deactivating the plurality of beams for communications between the communications device and the NTN in a Radio Resource Control, RRC, signal.

Paragraph 78. A method according to any of paragraphs 61 to 77, wherein the plurality of beams provided by the NTN comprise
a first beam and a second beam belonging to different communications cells provided by the NTN.

Paragraph 79. A method according to paragraph 78, comprising
receiving, from the communications device, an indication that the communications device is a multi-panel communications device configured to communicate with the NTN via the first and second beam simultaneously, and in response,
modifying the condition for activating the first beam by extending at least one of
the time period during which the first beam should be inactive for communications between the communications device and the NTN, and
the location range during which the first beam should be inactive for communications between the communications device and the NTN, the at least one of the extended time period and the extended location range overlapping at least partially with the time period or the location range in the condition for deactivating the second beam.

Paragraph 80. A method according to any of paragraphs 61 to 79, wherein the plurality of beams provided by the NTN comprise
a first beam and a second beam belonging to the same communications cell provided by the NTN.

Paragraph 81. A method of operating a communications device to perform beam failure recovery with a non-terrestrial network, NTN, the method comprising,
receiving, from the NTN, a beam failure recovery configuration identifying one or more beams provided by the NTN as candidate beams for communications between the communications device and the NTN after beam failure, the beam failure recovery configuration comprising an indication of a time period for each of the one or more candidate beams during which the communications device is expected to be in a coverage area provided by the respective candidate beam,
determining that beam failure has occurred,
selecting one of the candidate beams for communications between the communications device and the NTN based on the indication of the time period for each of the one or more candidate beams, and
transmitting, to the NTN, a control message indicating the selected beam.

Paragraph 82. A method according to paragraph 81, wherein the transmitting the control message indicating the selected beam comprises
determining a location of the communications device, and
including an indication of the location of the communications device in the control message transmitted to the NTN.

Paragraph 83. A method according to paragraph 82, wherein the indication of the location of the communications device comprises Global Navigation Satellite System, GNSS, co-ordinates of the communications device.

Paragraph 84. A method according to paragraph 83, wherein the indication of the location of the communications device comprises a subset of the most significant bits of the GNSS co-ordinates of the communications device.

Paragraph 85. A method according to any of paragraphs 81 to 84, wherein the control message is an enhanced beam failure recovery, BFR, medium access control, MAC, control element, CE or a truncated enhanced BFR MAC CE.

Paragraph 86. A method according to any of paragraphs 81 to 85, wherein the selecting the one of the candidate beams comprises
determining a link quality for each of the one or more candidate beams,
selecting the one of the candidate beams based on the indication of the time period for each of the one or more candidate beams and the determined link quality for each of the one or candidate beams.

Paragraph 87. A method according to paragraph 86, wherein the determining the link quality of each of the one or more candidate beams comprises
determining a reference signal received power, RSRP, for each of the one or more candidate beams.

Paragraph 88. A method of operating non-terrestrial network, NTN, infrastructure equipment to perform beam failure recovery with a communications device, the method comprising,
determining, for the communications device, one or more beams provided by the NTN as candidate beams for communications between the communications device and the NTN after beam failure,
determining a time period for each of the one or more candidate beams during which the communications device is expected to be in a coverage area provided by the respective candidate beam,
transmitting a beam failure recovery configuration to the communications device identifying the one or more candidate beams and comprising an indication of the time period for each of the one or more candidate beams during which the communications device is expected to be in the coverage area provided by the respective candidate beam, and
receiving, from the communications device, a control message indicating a selected one of the candidate beams.

Paragraph 89. A method according to paragraph 88, wherein the control message received from the communications device comprises
an indication of a location of the communications device, and the method comprises
identifying the location of the communications device based on the indication of the location of the communications device.

Paragraph 90. A method according to paragraph 89, wherein the indication of the location of the communications device comprises Global Navigation Satellite System, GNSS, co-ordinates of the communications device.

Paragraph 91. A method according to paragraph 90, wherein the indication of the location of the communications device comprises a subset of the most significant bits of the GNSS co-ordinates of the communications device.

Paragraph 92. A method according to any of paragraphs 88 to 91, wherein the control message is an enhanced beam failure recovery, BFR, medium access control, MAC, control element, CE or a truncated enhance BFR MAC CE.

Paragraph 93. A method according to any of paragraphs 89 to 92, comprising
determining an updated time period during which the communications device is expected to be in the coverage area provided by the selected beam based on the indication of the location of the communications device received in the control message,
evaluating the updated time period by comparing the updated time period with the time period during which the communications device is expected to be in the coverage area provided by the selected beam transmitted in the beam failure recovery configuration,
determining, based on a result of the evaluation and the indication of the location of the communications device received in the control message, an updated time period during which the communications device is expected to be in the coverage area provided by each of the other candidate beams,
transmitting, to the communications device, an indication of the updated time period during which the communications device is expected to be in the coverage area provided by each respective candidate beam.

Paragraph 94. A communications device operable to perform an intra-cell or inter-cell mobility procedure with a non-terrestrial network, NTN, the communications device comprising,
a transmitter configured to transmit signals,
a receiver configured to receive signals, and
a controller configured to control the transmitter and the receiver to
receive, from the NTN, an indication of a plurality of beams belonging to the same or different communications cells provided by the NTN,
receive, from the NTN, a condition for activating each of the plurality of beams for communications between the communications device and the NTN,
   determining that the condition is being met for at least one of the plurality of beams,
activate the at least one beam for communications between the communications device and the NTN for as long as the condition is being met, wherein the condition comprises at least one of
a time period condition for each of the plurality of beams indicating a time period during which the respective beam should be active for communications between the communications device and the NTN, and
a location range condition for each of the plurality of beams indicating a location range for the communications device during which the respective beam should be active for communications between the communications device and the NTN.

Paragraph 95. Non-terrestrial network, NTN, infrastructure equipment operable to perform an intra-cell or inter-cell mobility procedure with a communications device, the NTN infrastructure equipment comprising,
a transmitter configured to transmit signals,
a receiver configured to receive signals, and
a controller configured to control the transmitter and the receiver to
determine a condition for the communications device to activate each of a plurality of beams belonging to the same or different communications cells provided by the NTN for communications between the communications device and the NTN,
transmit, to the communications device, an indication of the plurality of beams provided by the NTN,
transmit, to the communications device, the condition for activating each of the plurality of beams for communications between the communications device and the NTN, wherein the condition comprises at least one of
a time period condition for each of the plurality of beams indicating a time period during which the respective beam should be active for communications between the communications device and the NTN, and
a location range condition for each of the plurality of beams indicating a location range for the communications device during which the respective beam should be active for the communications between the communications device and the NTN.

Paragraph 96. A communications device operable to perform an intra-cell or inter-cell mobility procedure with a non-terrestrial network, NTN, the communications device comprising,
a transmitter configured to transmit signals,
a receiver configured to receive signals, and
a controller configured to control the transmitter and the receiver to
receive, from the NTN, an indication of a plurality of beams belonging to the same or different communications cells provided by the NTN,
receive, from the NTN, a condition for deactivating each of the plurality of beams for communications between the communications device and the NTN,
determining that the condition is being met for at least one of the plurality of beams,
deactivate the at least one beam for communications between the communications device and the NTN for as long as the condition is being met, wherein the condition comprises at least one of
a time period condition for each of the plurality of beams indicating a time period during which the respective beam should be inactive for communications between the communications device and the NTN, and
a location range condition for each of the plurality of beams indicating a location range for the communications device during which the respective beam should be inactive for communications between the communications device and the NTN.

Paragraph 97. Non-terrestrial network, NTN, infrastructure equipment operable to perform an intra-cell or inter-cell mobility procedure with a communications device, the NTN infrastructure equipment comprising,
a transmitter configured to transmit signals,
a receiver configured to receive signals, and
a controller configured to control the transmitter and the receiver to
determine a condition for the communications device to deactivate each of a plurality of beams belonging to the same or different communications cells provided by the NTN for communications between the communications device and the NTN,
transmit, to the communications device, an indication of the plurality of beams provided by the NTN,
transmit, to the communications device, the condition for deactivating each of the plurality of beams for communications between the communications device and the NTN, wherein the condition comprises at least one of
a time period condition for each of the plurality of beams indicating a time period during which the respective beam should be inactive for communications between the communications device and the NTN, and
a location range condition for each of the plurality of beams indicating a location range for the communications device during which the respective beam should be inactive for the communications between the communications device and the NTN.

Paragraph 98. A communications device operable to perform beam failure recovery with a non-terrestrial network, NTN, the communications device comprising,
a transmitter configured to transmit signals,
a receiver configured to receive signals, and
a controller configured to control the transmitter and the receiver to
receive, from the NTN, a beam failure recovery configuration identifying one or more beams provided by the NTN as candidate beams for communications between the communications device and the NTN after beam failure, the beam failure recovery configuration comprising an indication of a time period for each of the one or more candidate beams during which the communications device is expected to be in a coverage area provided by the respective candidate beam,
determine that beam failure has occurred,
select one of the candidate beams for communications between the communications device and the NTN based on the indication of the time period for each of the one or more candidate beams, and
transmit, to the NTN, a control message indicating the selected beam.

Paragraph 99. Non-terrestrial network, NTN, infrastructure equipment operable to perform beam failure recovery with a communications device, the NTN infrastructure equipment comprising,
a transmitter configured to transmit signals,
a receiver configured to receive signals, and
a controller configured to control the transmitter and the receiver to
determine, for the communications device, one or more beams provided by the NTN as candidate beams for communications between the communications device and the NTN after beam failure,
determine a time period for each of the one or more candidate beams during which the communications device is expected to be in a coverage area provided by the respective candidate beam,
transmit a beam failure recovery configuration to the communications device identifying the one or more candidate beams and comprising an indication of the time period for each of the one or more candidate beams during which the communications device is expected to be in the coverage area provided by the respective candidate beam, and
receive, from the communications device, a control message indicating a selected one of the candidate beams.

Paragraph 100. Circuitry for a communications device operable to perform an intra-cell or inter-cell mobility procedure with a non-terrestrial network, NTN, the circuitry comprising,
transmitter circuitry configured to transmit signals,
receiver circuitry configured to receive signals, and
controller circuitry configured to control the transmitter circuitry and the receiver circuitry to
receive, from the NTN, an indication of a plurality of beams belonging to the same or different communications cells provided by the NTN,
receive, from the NTN, a condition for activating each of the plurality of beams for communications between the communications device and the NTN, determining that the condition is being met for at least one of the plurality of beams,
activate the at least one beam for communications between the communications device and the NTN for as long as the condition is being met, wherein the condition comprises at least one of
a time period condition for each of the plurality of beams indicating a time period during which the respective beam should be active for communications between the communications device and the NTN, and
a location range condition for each of the plurality of beams indicating a location range for the communications device during which the respective beam should be active for communications between the communications device and the NTN.

Paragraph 101. Circuitry for non-terrestrial network, NTN, infrastructure equipment operable to perform an intra-cell or inter-cell mobility procedure with a communications device, the circuitry comprising,
transmitter circuitry configured to transmit signals,
receiver circuitry configured to receive signals, and
controller circuitry configured to control the transmitter circuitry and the receiver circuitry to
determine a condition for the communications device to activate each of a plurality of beams belonging to the same or different communications cells provided by the NTN for communications between the communications device and the NTN,
transmit, to the communications device, an indication of the plurality of beams provided by the NTN,
transmit, to the communications device, the condition for activating each of the plurality of beams for communications between the communications device and the NTN, wherein the condition comprises at least one of
a time period condition for each of the plurality of beams indicating a time period during which the respective beam should be active for communications between the communications device and the NTN, and
a location range condition for each of the plurality of beams indicating a location range for the communications device during which the respective beam should be active for the communications between the communications device and the NTN.

Paragraph 102. Circuitry for a communications device operable to perform an intra-cell or inter-cell mobility procedure with a non-terrestrial network, NTN, the circuitry comprising,
transmitter circuitry configured to transmit signals,
receiver circuitry configured to receive signals, and
controller circuitry configured to control the transmitter and the receiver to
receive, from the NTN, an indication of a plurality of beams belonging to the same or different communications cells provided by the NTN,
receive, from the NTN, a condition for deactivating each of the plurality of beams for communications between the communications device and the NTN,
determining that the condition is being met for at least one of the plurality of beams,
deactivate the at least one beam for communications between the communications device and the NTN for as long as the condition is being met, wherein the condition comprises at least one of
a time period condition for each of the plurality of beams indicating a time period during which the respective beam should be inactive for communications between the communications device and the NTN, and
a location range condition for each of the plurality of beams indicating a location range for the communications device during which the respective beam should be inactive for communications between the communications device and the NTN.

Paragraph 103. Circuitry for non-terrestrial network, NTN, infrastructure equipment operable to perform an intra-cell or inter-cell mobility procedure with a communications device, the circuitry comprising,
transmitter circuitry configured to transmit signals,
receiver circuitry configured to receive signals, and
controller circuitry configured to control the transmitter circuitry and the receiver circuitry to
determine a condition for the communications device to deactivate each of a plurality of beams belonging to the same or different communications cells provided by the NTN for communications between the communications device and the NTN,
transmit, to the communications device, an indication of the plurality of beams provided by the NTN,
transmit, to the communications device, the condition for deactivating each of the plurality of beams for communications between the communications device and the NTN, wherein the condition comprises at least one of
a time period condition for each of the plurality of beams indicating a time period during which the respective beam should be inactive for communications between the communications device and the NTN, and
a location range condition for each of the plurality of beams indicating a location range for the communications device during which the respective beam should be inactive for the communications between the communications device and the NTN.

Paragraph 104. Circuitry for a communications device operable to perform beam failure recovery with a non-terrestrial network, NTN, the circuitry comprising,
transmitter circuitry configured to transmit signals,
receiver circuitry configured to receive signals, and
controller circuitry configured to control the transmitter and the receiver to
receive, from the NTN, a beam failure recovery configuration identifying one or more beams provided by the NTN as candidate beams for communications between the communications device and the NTN after beam failure, the beam failure recovery configuration comprising an indication of a time period for each of the one or more candidate beams during which the communications device is expected to be in a coverage area provided by the respective candidate beam,
determine that beam failure has occurred,
select one of the candidate beams for communications between the communications device and the NTN based on the indication of the time period for each of the one or more candidate beams, and
transmit, to the NTN, a control message indicating the selected beam.

Paragraph 105. Circuitry for non-terrestrial network, NTN, infrastructure equipment operable to perform beam failure recovery with a communications device, the circuitry comprising,
transmitter circuitry configured to transmit signals,
receiver circuitry configured to receive signals, and
controller circuitry configured to control the transmitter and the receiver to
determine, for the communications device, one or more beams provided by the NTN as candidate beams for communications between the communications device and the NTN after beam failure,
determine a time period for each of the one or more candidate beams during which the communications device is expected to be in a coverage area provided by the respective candidate beam,
transmit a beam failure recovery configuration to the communications device identifying the one or more candidate beams and comprising an indication of the time period for each of the one or more candidate beams during which the communications device is expected to be in the coverage area provided by the respective candidate beam, and
receive, from the communications device, a control message indicating a selected one of the candidate beams.

Paragraph 106. A wireless communications network comprising a communications device according to paragraph 94, 96, or 98 and NTN infrastructure equipment according to paragraph 95, 97 or 99.

Paragraph 107. A computer program comprising instructions which, when loaded onto a computer, cause the computer to perform a method according to any of paragraphs 1 to 93.

Paragraph 108. A non-transitory computer-readable storage medium storing a computer program according to paragraph 107.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] TR 38.811 V15.4.0, “Study on New Radio (NR) to support non terrestrial networks (Release 15)”, 3^{rd} Generation Partnership Project, October 2020.
[2] Holma H. and Toskala A, “LTE for UMTS OFDMA and SC-FDMA based radio access”, John Wiley and Sons, 2009.
[3] TS 38.321 V17.0.0, Medium Access Control (MAC) Specification (Release 17), 3^{rd} generation Partnership Project, March 2022.
[4] TS 38.212 V17.1.0, “NR; Multiplexing and channel coding (Release 17)”, 3rd generation Partnership Project, March 2022.
[5] TS 38.331 V17.0.0, “NR; Radio Resource Control (RRC) protocol specification (Release 17)”, 3rd generation Partnership Project, March 2022.
[6] International Patent Application, WO 2020/165244 A1, “NETWORK ENTITY, USER EQUIPMENT AND METHOD”, published 20 Aug. 2020.
[7] TS 38.300 V17.0.0, “NR; NR and NG-RAN Overall Description; Stage 2 (Release 17), 3^{rd} generation Partnership Project, March 2022.
[8] TS 38.213 V17.1.0, “NR; Physical layer procedures for control (Release 17)”, 3rd generation Partnership Project, March 2022.
[9] TS 38.133 V17.0.0, “NR; Base Station (BS) ElectroMagnetic Compatibility (EMC) (Release 17)”, 3rd generation Partnership Project, March 2022.

1. A method of operating a communications device to perform an intra-cell or inter-cell mobility procedure with a non-terrestrial network, NTN, the method comprising,
receiving, from the NTN, an indication of a plurality of beams belonging to the same or different communications cells provided by the NTN,
receiving, from the NTN, a condition for activating each of the plurality of beams for communications between the communications device and the NTN,
determining that the condition is being met for at least one of the plurality of beams,
activating the at least one beam for communications between the communications device and the NTN for as long as the condition is being met, wherein the condition comprises at least one of
a time period condition for each of the plurality of beams indicating a time period during which the respective beam should be active for communications between the communications device and the NTN, and
a location range condition for each of the plurality of beams indicating a location range for the communications device during which the respective beam should be active for communications between the communications device and the NTN.

2. A method according to claim 1, comprising
determining that the condition is no longer being met for the at least one beam, and, in response,
deactivating the at least one beam for communications between the communications device and the NTN.

3. A method according to claim 1, wherein the determining that the condition is being met for the at least one beam comprises
determining that the time period condition and the location range condition are being met for the at least one beam.

4. A method according to claim 1, wherein the location range is a distance range of the communications device from a reference location.

5. A method according to claim 4, wherein the determining that the condition is being met comprises
determining a current location of the communications device,
identifying the reference location from the location range condition,
determining a distance between the current location of the communications device and the reference location, and
determining that the distance between the current location of the communications device and the reference location is within the distance range.

6. A method according to claim 1, wherein the determining that the condition is being met comprises
determining a current time,
identifying, from the time period condition, a start time of the time period during which the at least one beam should be active for communications between the communications device and the NTN,
identifying, from the time period condition, an end time of the time period during which the at least one beam should be active for communications between the communications device and the NTN,
determining that the current time is equal to or later than the start time and earlier than the end time.

7. A method according to claim 1, comprising
determining a location of the communications device, and
transmitting location information to the NTN identifying the location of the communications device for the NTN to determine the time period condition and/or location range condition for the communications device.

8. A method according to claim 1, comprising
transmitting a radio link quality report to the NTN for the NTN to determine location information identifying a location of the communications device, the location information being for the NTN to determine the time period condition and/or location range condition.

9. A method according to claim 1, comprising
receiving a reference signal from the NTN, and in response,
transmitting an assistance signal to the NTN for the NTN to determine location information identifying a location of the communications device based on the reference signal and the assistance signal, the location information being for the NTN to determine the time period condition and/or location range condition.

10. A method according to claim 1, wherein the receiving the indication of the plurality of beams provided by the NTN comprises
receiving the indication of the plurality of beams provided by the NTN in a medium access control, MAC, control element, CE.

11. A method according to claim 10, wherein the MAC CE comprises the condition for activating each of the plurality of beams for communications between the communications device and the NTN.

12. A method according to claim 1, wherein the indication of the plurality of beams provided by the NTN is an indication of a transmission configuration indicator, TCI, state for each of the plurality of beams provided by the NTN.

13. A method according to claim 12, wherein the TCI states are a sub-set of a plurality of TCI states pre-configured for the communications device.

14. A method according to claim 13, wherein the plurality of pre-configured TCI states are configured by
receiving, from the NTN, a Radio Resource Control, RRC, signal indicating the plurality of pre-configured TCI states.

15. A method according to claim 1, wherein the receiving the condition for activating the plurality of beams for communications between the communications device and the NTN comprises receiving the condition for activating the plurality of beams for communications between the communications device and the NTN in a Radio Resource Control, RRC, signal.

16. A method according to claim 1, wherein the plurality of beams provided by the NTN comprise
a first beam and a second beam, the first beam being the beam for which the condition is being met, and the method comprises
determining that the condition is no longer being met for the first beam, and, in response,
deactivating the first beam for communications between the communications device and the NTN,
determining that the condition for the second beam is being met, and in response,
activating the second beam for communications between the communications device and the NTN.

17. A method according to claim 16, wherein the first beam and the second beam belong to different communications cells provided by the NTN.

18.-19. (canceled)

20. A method according to claim 16, wherein the first beam and the second beam belong to the same communications cell provided by the NTN.

21.-103. (canceled)

104. Circuitry for a communications device operable to perform beam failure recovery with a non-terrestrial network, NTN, the circuitry comprising,
transmitter circuitry configured to transmit signals,
receiver circuitry configured to receive signals, and
controller circuitry configured to control the transmitter and the receiver to
receive, from the NTN, a beam failure recovery configuration identifying one or more beams provided by the NTN as candidate beams for communications between the communications device and the NTN after beam failure, the beam failure recovery configuration comprising an indication of a time period for each of the one or more candidate beams during which the communications device is expected to be in a coverage area provided by the respective candidate beam,
determine that beam failure has occurred,
select one of the candidate beams for communications between the communications device and the NTN based on the indication of the time period for each of the one or more candidate beams, and
transmit, to the NTN, a control message indicating the selected beam.

105. Circuitry for non-terrestrial network, NTN, infrastructure equipment operable to perform beam failure recovery with a communications device, the circuitry comprising,
transmitter circuitry configured to transmit signals,
receiver circuitry configured to receive signals, and
controller circuitry configured to control the transmitter and the receiver to
determine, for the communications device, one or more beams provided by the NTN as candidate beams for communications between the communications device and the NTN after beam failure,
determine a time period for each of the one or more candidate beams during which the communications device is expected to be in a coverage area provided by the respective candidate beam,
transmit a beam failure recovery configuration to the communications device identifying the one or more candidate beams and comprising an indication of the time period for each of the one or more candidate beams during which the communications device is expected to be in the coverage area provided by the respective candidate beam, and
receive, from the communications device, a control message indicating a selected one of the candidate beams.

106.-108. (canceled)
